(19) United States
(12) Patent Application Publication
(10) Pub. No.: US 2024/0389128 A1
(43) Pub. Date: Nov. 21, 2024

(54) Data Transmission Method, Electronic Device, Chip, and Storage Medium

(71) Applicant: Huawei Technologies Co., Ltd., Shenzhen (CN)

(72) Inventors: Jingyun Zhang, Shanghai (CN); Xudong Zhu, Shanghai (CN); Meng Jin, Shanghai (CN); Yao Zhao, Shanghai (CN)

(21) Appl. No.: 18/430,104

(22) Filed: Feb. 1, 2024

Related U.S. Application Data
(63) Continuation of application No. PCT/CN2022/108661, filed on Jul. 28, 2022.

(30) Foreign Application Priority Data
Aug. 2, 2021 (CN) 202110883114.5
Sep. 14, 2021 (CN) 202111076936.9

(51) Int. Cl. H04W 72/543; H04W 28/02; H04W 72/40; H04W 76/15

(52) U.S. Cl. CPC H04W 72/543; H04W 28/0215; H04W 72/40; H04W 76/15

(57) ABSTRACT

A method is applied to an electronic device. The electronic device includes a basic application layer, a basic service layer, and an access layer, the access layer includes a first access layer and a second access layer, and the first access layer and the second access layer support different data transmission capabilities. The method includes: The basic application layer requests the basic service layer to establish a service channel for a communication service of an application. The basic service layer establishes a transmission channel group for the communication service if the communication service supports multilink transmission. The transmission channel group includes a first service channel and/or a second service channel, the first service channel corresponds to the first access layer, and the second service channel corresponds to the second access layer. The electronic device transmits service data of the communication service based on the transmission channel group.

### CROSS-REFERENCE TO RELATED APPLICATIONS

This application is a continuation of International Patent Application No. PCT/CN2022/108661, filed on Jul. 28, 2022, which claims priorities to Chinese Patent Application No. 202110883114.5, filed on Aug. 2, 2021 and Chinese Patent Application No. 202111076936.9, filed on Sep. 14, 2021. All of the aforementioned patent applications are hereby incorporated by reference in their entireties.

### TECHNICAL FIELD

This application relates to the field of communication technologies, and in particular, to a data transmission method, an electronic device, a chip, and a storage medium.

### BACKGROUND

With development of an internet of things technology, a wireless short-range communication technology is applied to fields more widely. For example, in the smart home field, a mobile phone may implement an end-to-end connection to a smart TV based on a wireless short-range communication technology, perform projection onto the smart TV, and the like.

Currently, wireless short-range communication technologies are independent of each other. When two electronic devices are connected, only one of the wireless short-range communication technologies can be selected for a connection based on a preset requirement of an application. Quality of service (for example, a specific bandwidth, a bit rate, and a latency) provided by a communication link established between the two electronic devices is a fixed value agreed on by two parties. However, a same service usually has different requirements for quality of service of the communication link at different stages (for example, a stage of playing a standard-definition video and a stage of playing a high-definition video in a video projection service). Therefore, an existing data transmission method possibly cannot meet various data transmission requirements of a service.

### SUMMARY

This application provides a data transmission method, an electronic device, a chip, and a storage medium, to resolve a problem that an existing data transmission method cannot meet various data transmission requirements of a service.

To achieve the foregoing objective, the following technical solutions are used in this application.

According to a first aspect, an embodiment of this application provides a data transmission method, applied to an electronic device. The electronic device includes a basic application layer, a basic service layer, and an access layer, the access layer includes a first access layer and a second access layer, and the first access layer and the second access layer support different data transmission capabilities.

The method includes: The basic application layer requests the basic service layer to establish a service channel for a communication service of an application. The basic service layer establishes a transmission channel group for the communication service if the communication service supports multilink transmission. The transmission channel group includes a first service channel and/or a second service channel, the first service channel corresponds to the first access layer, and the second service channel corresponds to the second access layer. The electronic device transmits service data of the communication service based on the transmission channel group.

In the method provided in this embodiment of this application, for the communication service that supports multilink transmission, the electronic device establishes the transmission channel group for the communication service, and transmits the service data of the communication service based on the transmission channel group. Because the transmission channel group is established at a basic service layer of a communication protocol used by the electronic device, in a service data transmission process, after a service requirement changes or a data transmission capability of the electronic device is improved, the basic service layer may adaptively transmit the service data through one or more service channels in the transmission channel group, to meet service requirements at different stages.

In addition, when the transmission channel group includes only a plurality of service channels, in the service data transmission process, even if one service channel is faulty, the transmission channel group does not need to be reconfigured, and the service data may still be transmitted.

In some embodiments, the first access layer is a SparkLink basic SLB access layer, the first service channel is an SLB service channel, and the SLB access layer supports a high-bandwidth data transmission capability; and the second access layer is a SparkLink low energy SLE access layer, the second service channel is an SLE service channel, and the SLE access layer supports a low-power data transmission capability. According to the method provided in this embodiment of this application, the electronic device can provide a high-bandwidth and/or low-power data transmission capability for the communication service.

In some embodiments, the establishing, by the basic service layer, a transmission channel group for the communication service if the communication service supports multilink transmission includes: if the communication service supports multilink transmission, allocating, by the basic service layer, the first service channel to the transmission channel group of the communication service when a resource of the first access layer supports to serve the communication service; and/or if the communication service supports multilink transmission, allocating, by the basic service layer, the second service channel to the transmission channel group of the communication service when a resource of the second access layer supports to serve the communication service.

In some embodiments, if the transmission channel group includes the first service channel and the second service channel, the transmitting, by the electronic device, service data of the communication service based on the transmission channel group includes: transmitting, by the electronic device, the service data through the first service channel and the second service channel; or individually transmitting, by the electronic device, the service data through the first service channel; or individually transmitting, by the electronic device, the service data through the second service channel.

In other words, when the transmission channel group includes a plurality of service channels, the electronic device may transmit the service data through only one service channel in the transmission channel group, or may simultaneously transmit the service data through the plurality of service channels in the transmission channel group. This is specifically determined based on a preset transmission policy.

In some embodiments, the transmitting, by the electronic device, the service data through the first service channel and the second service channel includes: The basic service layer obtains target service data from the basic application layer. The target service data is service data that carries a port number (port), and the port is mapped onto all service channels in the transmission channel group. The basic service layer processes the target service data, to obtain target service data that carries a first TCID and target service data that carries a second TCID. The first TCID is an identifier of the first service channel, and the second TCID is an identifier of the second service channel. The basic service layer sends, to the first access layer, the target service data that carries the first TCID, and sends, to the second access layer, the target service data that carries the second TCID. The first access layer transmits, to a peer device, the target service data that carries the first TCID, and the second access layer transmits, to the peer device, the target service data that carries the second TCID.

In some embodiments, that the electronic device transmits the service data through the first service channel includes: The basic service layer obtains target service data from the basic application layer. The target service data is service data that carries a port number (port). The basic service layer processes target service data that carries the port, to obtain target service data that carries a first TCID. The basic service layer sends, to the first access layer, the target service data that carries the first TCID. The first access layer sends, to a peer device, the target service data that carries the first TCID.

In some embodiments, before the basic service layer obtains the target service data from the basic application layer, the method further includes: The basic application layer receives the service data sent by the application; and adds the port to the service data, to obtain the target service data.

It may be learned from the foregoing embodiment that, regardless of whether the transmission channel group includes one or more service channels, when the electronic device transmits the service data based on the transmission channel group, the basic application layer performs a same operation (that is, adds the port to the service data). Subsequently, the basic service layer determines a service channel specifically used in the transmission process. Based on this, when the basic service layer adjusts the service channel (for example, establishes, disconnects, or switches the service channel) used in a communication process, a user does not need to enter a control operation again, to improve user experience.

In some embodiments, in the process of transmitting, by the electronic device, service data based on the transmission channel group, the method further includes: If the transmission channel group includes an original service channel, the original service channel is either of the first service channel and the second service channel, the basic service layer determines to switch to a target service channel to process the communication service, and an access layer corresponding to the target service channel can provide a service for the communication service, the basic service layer updates the transmission channel group. The updated transmission channel group further includes the target service channel. The service data is switched to the target service channel for transmission.

The target service channel is the second service channel when the transmission channel group before updating includes the first service channel; and the target service channel is the first service channel when the transmission channel group before updating includes the second service channel.

In some embodiments, that the basic service layer switches the service data to the target service channel for transmission includes: The basic service layer disconnects the original service channel in the transmission channel group, and switches the service data to the target service channel.

In some embodiments, that the basic service layer determines to switch to the target service channel to process the communication service includes: the electronic device enters a low power mode, or power of the electronic device is less than a preset value, and correspondingly, the target service channel is the second service channel, and the second service channel supports a low-power data transmission capability.

In some embodiments, that the basic service layer determines to switch to the target service channel to process the communication service includes: a quality of service requirement of the communication service is improved, or a service capability of an access layer corresponding to the target service channel is improved, and correspondingly, the target service channel is the first service channel, and the first service channel supports a high-bandwidth data transmission capability.

According to a second aspect, an embodiment of this application provides a data transmission apparatus. The apparatus includes a basic application layer, a basic service layer, and an access layer, the access layer includes a first access layer and a second access layer, and the first access layer and the second access layer support different data transmission capabilities.

The basic application layer is configured to request the basic service layer to establish a service channel for a communication service of an application.

The basic service layer is configured to establish a transmission channel group for the communication service if the communication service supports multilink transmission. The transmission channel group includes a first service channel and/or a second service channel, the first service channel corresponds to the first access layer, and the second service channel corresponds to the second access layer. The transmission channel group is used by an electronic device to transmit service data.

An access layer is configured to transmit the service data at the first access layer and/or the second access layer.

According to a third aspect, an embodiment of this application provides an electronic device. The electronic device is configured to perform the data transmission method shown in the first aspect and various embodiments of the first aspect.

According to a fourth aspect, an embodiment of this application provides a chip. The chip includes a processor, and the processor executes a computer program stored in a memory, to implement the data transmission method shown in the first aspect and various embodiments of the first aspect.

According to a fifth aspect, an embodiment of this application provides a computer-readable storage medium. The computer-readable storage medium stores a computer program, and when the computer program is executed by a processor, the data transmission method shown in the first aspect and various embodiments of the first aspect is implemented.

According to a sixth aspect, an embodiment of this application provides a computer program product. When the computer program product runs on an electronic device, the electronic device is enabled to implement the data transmission method shown in the first aspect and various embodiments of the first aspect.

It may be understood that, for beneficial effects of the second aspect to the sixth aspect, refer to related descriptions in the first aspect. Details are not described herein again.

According to a seventh aspect, an embodiment of this application provides a data transmission method, applied to an electronic device. The electronic device includes a basic application layer, a basic service layer, and an access layer, the access layer includes a first access layer and a second access layer, and the first access layer and the second access layer support different data transmission capabilities.

The method includes: The basic application layer requests the basic service layer to establish a service channel for a communication service of an application. The basic service layer establishes the service channel for the communication service if the communication service supports multilink transmission. The service channel can be mapped onto a first logical link and a second logical link, the first logical link is a link of the first access layer, and the second logical link is a link of the second access layer. The electronic device transmits service data of the communication service to a peer device at the first access layer and/or the second access layer corresponding to the service channel.

In the method provided in this embodiment of this application, for the communication service that supports multilink transmission, a service channel corresponding to the service can be mapped onto the first logical link and the second logical link. The electronic device may simultaneously transmit the service data through one or both of the two logical links based on a service requirement or a data transmission capability of the electronic device, to meet data transmission requirements of the service at different stages.

In some embodiments, that the service channel can be mapped onto the first logical link and the second logical link includes: The service channel is simultaneously mapped onto the first logical link and the second logical link; or the service channel is separately mapped onto the first logical link and the second logical link at different stages of service data transmission. When the service channel is simultaneously mapped onto a plurality of logical links, in a service data transmission process, the service data may still be transmitted even if one logical link is faulty.

In some embodiments, the first access layer is a SparkLink basic SLB access layer, the first logical link is an SLB logical link, and the SLB access layer supports a high-bandwidth data transmission capability; and the second access layer is a SparkLink low energy SLE access layer, the second logical link is an SLE logical link, and the SLE access layer supports a low-power data transmission capability.

In some embodiments, if the service channel is simultaneously mapped onto the first logical link and the second logical link, that the electronic device transmits service data of the communication service to a peer device at the first access layer and/or the second access layer corresponding to the service channel includes: The electronic device separately sends the service data in the service channel to the first logical link and the second logical link, to simultaneously transmit the service data at the first access layer and the second access layer; or the electronic device sends the service data in the service channel to the first logical link, to transmit the service data at the first access layer; or the electronic device sends the service data in the service channel to the second logical link, to transmit the service data at the second access layer.

In other words, when the service channel is simultaneously mapped onto the first logical link and the second logical link, the electronic device may transmit the service data through only one logical link, or may simultaneously transmit the service data through the two logical links. This is specifically determined based on a preset transmission policy.

In some embodiments, that the electronic device separately sends the service data in the service channel to the first logical link and the second logical link, to simultaneously transmit the service data at the first access layer and the second access layer includes: The basic service layer obtains target service data from the basic application layer. The target service data is service data that carries a port number (port). The basic service layer adds a service channel identifier TCID to the target service data; sends, to the first access layer, first service data in the target service data that carries the TCID; and sends, to the second access layer, second service data in the target service data that carries the TCID. The first access layer adds a first logical link identifier LCID to the first service data, and sends, to the peer device, the first service data that carries the first LCID; and the second access layer adds a second LCID to the second service data, and sends, to the peer device, the second service data that carries the second LCID.

In some embodiments, that the electronic device sends the service data in the service channel to the first logical link, to transmit the service data at the first access layer includes: The basic service layer obtains target service data from the basic application layer. The target service data is service data that carries a port number (port). The basic service layer adds a TCID to the target service data, and sends, to the first access layer, the target service data that carries the TCID. The first access layer adds a first LCID to the target service data that carries the TCID, and sends, to the peer device, the target service data that carries the first LCID.

In some embodiments, before the basic service layer obtains the target service data from the basic application layer, the method further includes: The basic application layer receives the service data sent by the application; and the basic application layer adds a port to the service data, to obtain the target service data.

It may be learned from the foregoing embodiment that, regardless of whether a service channel is mapped onto one or more logical links, in the service data transmission process, the basic application layer performs a same operation (that is, adds the port to the service data). Subsequently, the basic service layer determines a service channel specifically used in the transmission process. Based on this, when the basic service layer adjusts the service channel (for example, establishes, disconnects, or switches the service channel) used in a communication process, a user does not need to enter a control operation again, to improve user experience.

In some embodiments, that the service channel is separately mapped onto the first logical link and the second logical link at different stages of service data transmission includes: The basic service layer establishes a mapping relationship between the service channel and the target logical link if the service channel is mapped onto an original logical link, and the basic service layer determines to switch to the target logical link to process the communication service; and the service data is switched to the target logical link for transmission. The target logical link is the second logical link when the original logical link is the first logical link; or the target logical link is the first logical link when the original logical link is the second logical link.

In some embodiments, that the service data is switched to the target logical link for transmission includes: releasing the original logical link, and switching the service data to the target logical link for transmission.

In some embodiments, determining to switch to the target logical link to process the communication service includes: the electronic device enters a low power mode, or a power of the electronic device is less than a preset value, and correspondingly, the target logical link is the second logical link, and the second logical link supports a low-power data transmission capability.

In some embodiments, determining to switch to the target logical link to process the communication service includes: a quality of service requirement of the communication service is improved, or a service capability of the target logical link is improved, and correspondingly, the target service channel is the first logical link, and the first logical link supports a high-bandwidth data transmission capability.

According to an eighth aspect, an embodiment of this application provides a data transmission apparatus. The apparatus includes a basic application layer, a basic service layer, and an access layer, the access layer includes a first access layer and a second access layer, and the first access layer and the second access layer support different data transmission capabilities.

The basic application layer is configured to request the basic service layer to establish a service channel for a communication service of an application.

The basic service layer is configured to establish, by the basic service layer, the service channel for the communication service if the communication service supports multilink transmission. The service channel can map a first logical link and a second logical link, the first logical link is a link of the first access layer, and the second logical link is a link of the second access layer. The electronic device transmits service data of the communication service to a peer device at the first access layer and/or the second access layer corresponding to the service channel.

The access layer is configured to establish a logical link, and transmit the service data.

According to a ninth aspect, an embodiment of this application provides an electronic device. The electronic device is configured to perform the data transmission method shown in the seventh aspect and various embodiments of the seventh aspect.

According to a tenth aspect, an embodiment of this application provides a chip. The chip includes a processor, and the processor executes a computer program stored in a memory, to implement the data transmission method shown in the seventh aspect and various embodiments of the seventh aspect.

According to an eleventh aspect, an embodiment of this application provides a computer-readable storage medium. The computer-readable storage medium stores a computer program, and when the computer program is executed by a processor, the data transmission method shown in the seventh aspect and various embodiments of the seventh aspect is implemented.

According to a twelfth aspect, an embodiment of this application provides a computer program product. When the computer program product runs on an electronic device, the electronic device is enabled to implement the data transmission method shown in the seventh aspect and various embodiments of the seventh aspect.

It may be understood that, for beneficial effects of the eighth aspect to the twelfth aspect, refer to related descriptions in the seventh aspect. Details are not described herein again.

### BRIEF DESCRIPTION OF DRAWINGS

FIG. 1 is a schematic diagram of a wireless short-range communication system according to an embodiment of this application;

FIG. 2A is a schematic diagram 1 of a communicator according to an embodiment of this application;

FIG. 2B is a schematic diagram 2 of a communicator according to an embodiment of this application;

FIG. 3 is a schematic diagram of a wireless short-range communication protocol architecture according to an embodiment of this application;

FIG. 4A and FIG. 4B are a flowchart of a data transmission method according to an embodiment of Solution 1 of this application;

FIG. 5 is a schematic diagram of a transmission channel group according to an embodiment of Solution 1 of this application;

FIG. 6A and FIG. 6B are a flowchart of a data transmission method according to another embodiment of Solution 1 of this application;

FIG. 7A and FIG. 7B are a flowchart of a data transmission method according to still another embodiment of Solution 1 of this application;

FIG. 8A and FIG. 8B are a flowchart of a data transmission method according to an embodiment of Solution 2 of this application;

FIG. 9 is a schematic diagram of a mapping relationship between a service channel and a logical link according to an embodiment of Solution 2 of this application;

FIG. 10A to FIG. 10C show a procedure of establishing a logical link and a service channel according to an embodiment of Solution 2 of this application;

FIG. 11A and FIG. 11B show a procedure of establishing a logical link and a service channel according to another embodiment of Solution 2 of this application;

FIG. 12A and FIG. 12B show a procedure of establishing a logical link and a service channel according to still another embodiment of Solution 2 of this application;

FIG. 13 shows a procedure of establishing a logical link and a service channel according to yet another embodiment of Solution 2 of this application;

FIG. 14A and FIG. 14B are a flowchart of a data transmission method according to another embodiment of Solution 2 of this application;

FIG. 15 is a schematic diagram of a process of reconfiguring a service channel according to an embodiment of Solution 2 of this application;

FIG. 16A and FIG. 16B are a flowchart of a data transmission method according to still another embodiment of Solution 2 of this application;

FIG. 17 is a schematic diagram of a process of reconfiguring a service channel according to another embodiment of Solution 2 of this application; and

FIG. 18 is a schematic diagram of a structure of an electronic device according to an embodiment of this application.

### DESCRIPTION OF EMBODIMENTS

The following describes the technical solutions provided in embodiments of this application with reference to the accompanying drawings.

It should be understood that, in the descriptions of embodiments of this application, unless otherwise specified, “/” means “or”. For example, A/B may represent A or B. In this specification, “and/or” describes only an association relationship for describing associated objects and represents that three relationships may exist. For example, A and/or B may represent the following three cases: Only A exists, both A and B exist, and only B exists.

In embodiments, the terms “first” and “second” mentioned below are merely intended for a purpose of description, and shall not be understood as an indication or implication of relative importance or implicit indication of a quantity of indicated technical features. Therefore, a feature limited by “first” or “second” may explicitly or implicitly include one or more features. In descriptions of embodiments, unless otherwise specified, “a plurality of” means two or more.

With development of an internet of things technology, a wireless short-range communication technology is applied to fields such as a smart cockpit, smart home, a smartphone, and intelligent manufacture more widely. For example, a mobile phone may implement an end-to-end connection to a smart TV based on the wireless short-range communication technology, and perform projection onto the smart TV.

Currently, commonly used wireless short-range communication technologies include bluetooth (bluetooth, BT), wireless fidelity (wireless fidelity, Wi-Fi), ultra-wideband (ultra-wideband, UWB), and the like. Technologies such as Wi-Fi and UWB support high-bandwidth communication, and a data transmission speed is fast. However, technologies such as BT, NFC, and ZigBee support low-bandwidth, low-power, and low-rate communication, to help save device power.

However, current wireless short-range communication technologies are independent of each other. When two electronic devices are connected, only one wireless short-range communication technology can be selected from the wireless short-range communication technologies for a connection based on a preset requirement of an application. Quality of service (for example, a specific bandwidth, a bit rate, and a latency) provided by a communication link established to connect the two electronic devices is a fixed value agreed on by two parties. However, a same service (which is specifically a communication service) may have different requirements for quality of service of a communication link at different stages. For example, in a process in which the mobile phone projects a played video onto the smart TV, when a projected screen is a low-definition video (for example, a standard-definition video), a requirement of a projection service for a bandwidth of the communication link is low. However, after a user adjusts the video to a high-definition video (for example, a high-definition video), a requirement of the projection service for the bandwidth of the communication link is improved. It can be learned that an existing wireless short-range communication technology possibly cannot meet various data transmission requirements of a service.

Therefore, an embodiment of this application provides a new data transmission method based on a SparkLink alliance (SparkLink alliance) wireless short-range communication protocol architecture, to meet various data transmission requirements of a service to some extent.

FIG. 1 is a schematic diagram of a wireless short-range communication system to which a data transmission method provided in various embodiments of this application is applicable. As shown in FIG. 1, the system includes a first electronic device (referred to as a first device) and a second electronic device (referred to as a second device), and a connection is established between the first device and the second device based on a SparkLink alliance (sparklink alliance) wireless short-range communication protocol architecture.

In embodiments, an electronic device may be electronic devices in various fields such as a large-screen device, an artificial intelligence (artificial intelligence, AI) speaker, a high-fidelity (high-fidelity, Hi-Fi) speaker, a temperature sensor, a humidity sensor, and the like in the smart home field; a mobile phone, a tablet computer, a wearable device, an augmented reality (augmented reality, AR)/virtual reality (virtual reality, VR) device, a notebook computer, an ultra-mobile personal computer (ultra-mobile personal computer, UMPC), a netbook, a personal digital assistant (personal digital assistant, PDA), and the like in the intelligent terminal field; and a robotic arm, a camera, a joystick, a monitor, a sensor, a logistics vehicle, a smart shelf, and the like in the intelligent manufacture field. A specific type of the electronic device is not limited in embodiments of this application.

For ease of understanding of this application, the following explains and describes some nouns or terms in embodiments of this application.

### (1) SLB/SLE Access Layer

Wireless short-range communication technologies provided in embodiments of this application include a SparkLink basic (SparkLink basic, SLB) technology and a SparkLink low energy (SparkLink low energy, SLE) technology. The SLB access layer communicates based on the SLB technology, and supports high-bandwidth and high-rate data transmission, but has high power consumption. The SLE access layer communicates based on the SLE technology, and supports low-power, low-bandwidth, and low-rate data transmission, to help save device power.

### (2) G Node/T Node

In embodiments, in the SLB technology, electronic devices include a management node (that is, a grant node, G node for short) and a terminal node (that is, a terminal node, T node for short). One G node can manage at least one T node, and the G node and the T node are connected, to jointly complete a specific communication function.

### (3) Transmission Channel

A transmission channel (transmission channel, TC) is a channel of a basic service layer. A plurality of uplink ports (port) may be mapped onto the transmission channel, and a plurality of transmission channels may be mapped onto a same downlink logical channel or different downlink logical channels.

Transmission channels include a control channel and a service channel. The service channel is used to transmit service-related data, for example, a control instruction of a service and a media stream. The control channel is a basis for establishing different service channels between devices. In a process of establishing the service channel between devices, two electronic devices negotiate, on the control channel, about parameters required for establishing the service channel. Different service channels may be established between services based on a same control channel. The services may be services of a same application, or may be services of different applications.

In embodiments, the parameter required for establishing the service channel includes a transmission mode (for example, a flow mode, a flow control mode, a retransmission mode, and a basic mode), parameters in different transmission modes, a transmission channel identification (transmission channel identification, TCID) number, and a port (port) mapped onto the transmission channel.

### (4) Logical Link

The logical link (logical channel, LC) is a channel of an access layer, and one or more uplink transmission channels may be mapped onto the logical link. In some embodiments, the logical link may also be referred to as a logical channel.

### (5) Communicator

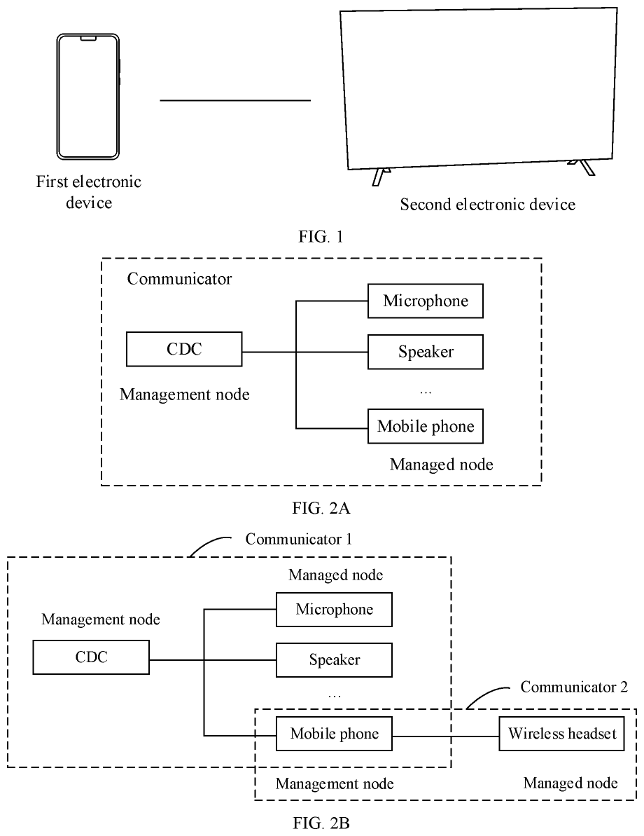

A communication system including a G node and all T nodes connected to the G node is referred to as a communicator. For example, as shown in FIG. 2A, an intelligent vehicle scenario is used as an example. A cockpit domain controller (cockpit domain controller, CDC) may be used as a G node, and various vehicle-mounted devices (for example, a microphone, a speaker, and a mobile phone) may be used as T nodes. The CDC and the vehicle-mounted device are connected, to jointly implement a cockpit entertainment function. In this case, the CDC and all vehicle-mounted devices form a communicator.

In some embodiments, the electronic device may be located in a plurality of communicators. For example, as shown in FIG. 2B, a CDC, a microphone, a speaker, and a mobile phone form a communicator 1. The CDC is a G node, and the microphone, the speaker, and the mobile phone are T nodes. The mobile phone and a wireless headset form a communicator 2. The mobile phone is a G node, and the wireless headset is a T node. The mobile phone is located in both the communicator 1 and the communicator 2.

The following describes a wireless short-range communication protocol architecture to which the data transmission method provided in embodiments of this application is applicable.

The electronic device usually stores various applications such as a Settings application, a Multi-screen coordination application, a Projection application, an Audio application, a Video application, a Gallery application, a Camera application, a Navigation application, a Maps application, an Email client, and a game application. In a running process of each application, if a provided service needs to perform wireless short-range communication with another electronic device, a communication function can be implemented based on a wireless short-range communication protocol architecture provided in embodiments.

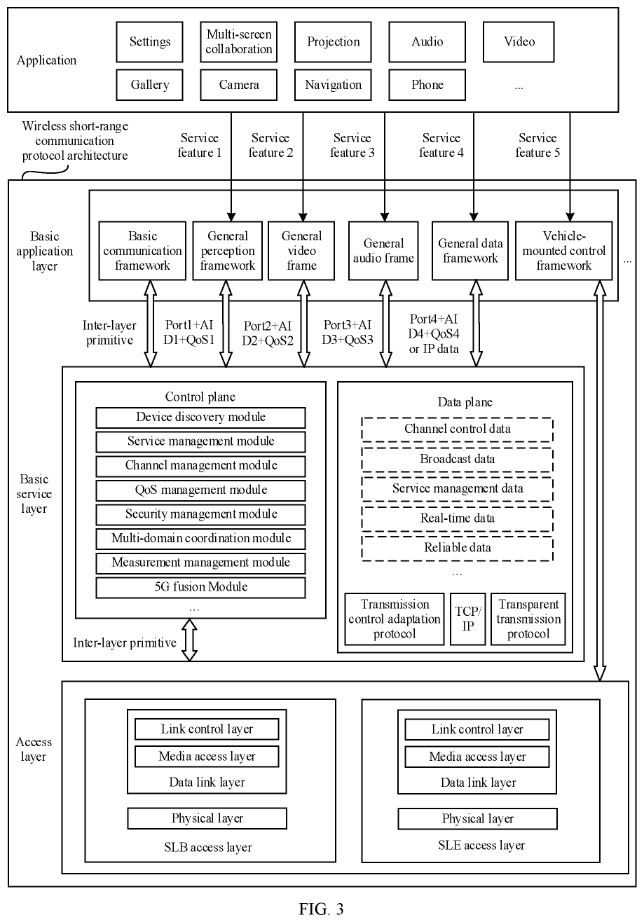

FIG. 3 is a schematic diagram of a wireless short-range communication protocol architecture according to an embodiment of this application. As shown in FIG. 3, the protocol architecture includes a basic application layer, a basic service layer, and a SparkLink access layer (which may also be referred to as an access layer). The basic application layer and the basic service layer may be collectively referred to as a host protocol architecture.

The basic application layer defines various general frameworks of different applications, and each framework defines a message format and an application rule that correspond to the framework. To implement communication between different devices on different platforms, the basic application layer formulates a framework for various possible and general application scenarios such as a general framework such as a basic communication framework, a general perception framework, a general video framework, a general audio framework, a general data framework, and a vehicle-mounted control framework. After receiving a service requirement, the basic application layer selects a corresponding frame to process a corresponding service.

The basic communication framework is configured to: set a device discovery mode and a device discovered mode (for example, a broadcast mode and a polling mode), set a filtering policy (for example, in an audio service scenario, a device discovery is only performed on an electronic device that supports an audio device), set a discoverable level, and the like. In addition, the basic communication framework is further configured to: trigger control channel selection (that is, select an SLB control channel or an SLE control channel based on the service requirement), and allocate a port number (port) to the service.

The general perception framework is configured to detect a user operation, device power information, signal strength, and the like. The user operation may include a touch instruction entered by a user on a screen of the electronic device, a mid-air control gesture entered by the user, a voice control instruction, and the like. The signal strength includes Wi-Fi signal strength, cellular signal strength, bluetooth signal strength, SLB signal strength, SLE signal strength, and the like.

The general video framework is configured to process data related to a video service, for example, encode and decode video data.

The general audio framework is configured to process data related to an audio service, for example, encode and decode audio data.

The general data framework is configured to encrypt and decrypt data, and the like.

The vehicle-mounted control framework is configured to process data related to a vehicle-mounted control service.

It should be understood that different applications usually have different service features, and the service features include an application identifier (application identifier, AID) and quality of service (quality of service, QoS). The QoS includes a bit rate, a latency, a sampling rate, a bit width, and the like. After detecting the service feature of the application, the basic application layer can select a corresponding functional module based on the service feature, to process the service, control the basic service layer to establish a service channel, and the like.

The basic service layer includes a control plane and a data plane. The control plane includes functional modules such as a device discovery module, a service management module, a channel management module, a QoS management module, a security management module, a multi-domain coordination module, a measurement management module, and a 5G fusion module. The data plane includes channel control data, broadcast data, service management data, real-time data, reliable data, and the like, and further includes a transmission control adaptation protocol, a transmission control protocol/internet protocol (transmission control protocol/internet protocol, TCP/IP), a transparent transmission protocol, and the like.

It should be noted that, in this embodiment, a module that includes the transmission control adaptation protocol on the data plane is referred to as a transmission control module. In addition, some data of the data plane (for example, channel control data in a dashed box in FIG. 3) is usually not included in an initial protocol architecture, but is gradually generated and stored in a process in which the electronic device uses the protocol architecture.

The device discovery module is mainly configured to: discover a peripheral device, advertise information about the device, perform a device discovery and discover a device through a broadcast/unicast data link, determine device information, and the like. In this embodiment, the device information includes information such as a domain name of the device, a media access control (media access control, MAC) address, a device role, a device model, and a device capability (for example, a wireless connection type and a supported communication protocol).

In a device discovery process, the device discovery module may be specifically configured to: broadcast device information of the electronic device, and scan an electronic device that meets the service requirement. It should be understood that, for a wireless short-range communication service, different service requirements usually correspond to different types of electronic devices. For example, when a mobile phone performs projection, a device discovery module of the mobile phone needs to scan a large-screen device that has a projection display function, for example, a television or a projector, without scanning an electronic device that does not support projection display, for example, another mobile phone or a wireless headset.

In addition, in this embodiment, the device discovery module further supports an SLB/SLE mutual discovery. To be specific, in a process of communication with a peer device based on an SLB technology, it can be found that the peer device enables an SLE communication function, or in a process of communication with a peer device based on an SLE technology, it can be found that the peer device enables an SLB communication function.

The service management module is configured to: provide an abstract data structure model for sending a control instruction and small data of the basic application layer, and provide a method for operating a data structure, for example, reading, writing, notifying, and indicating the data structure.

The channel management module is configured to: manage a transmission channel of the basic service layer, including establishing, maintaining, and releasing the transmission channel, and support to transmit data through a default transmission channel, or dynamically allocate a transmission channel to transmit data.

In addition, the channel management module is further configured to manage establishment and maintenance of a mapping relationship between layers, including managing a mapping relationship between a port of the basic application layer and a TCID of the basic service layer and a mapping relationship between a TCID of the basic service layer and a logical link identifier (logical channel identifier, LCID) of the access layer. The mapping relationship between the TCID and the port is a mapping relationship between data of the basic service layer and data of the basic application layer. The mapping relationship between the TCID and the LCID is a mapping relationship between data of the basic service layer and data of the access layer.

The QoS management module is configured to: manage a QoS request static table of a service, and negotiate about QoS with a peer end. Different services usually have different QoS request static tables. The QoS request static table includes parameters such as a transmission latency, a bit rate, a retransmission rate, a transmission bandwidth requirement, a service type, and a bit width. QoS management is performed, to resolve a problem such as a network latency and blocking in a process in which the electronic device communicates with a peer end, and improve communication quality.

The security management module is configured to manage a secure connection of the basic service layer, including identity authentication, air interface communication security protection, key update, privacy protection, application layer transmission security, password requirement, secure storage, secure execution, secure protection, and secure management of device information, and the like.

The multi-domain coordination module is configured to control information exchange between communicators in a scenario in which the electronic device is located in a plurality of communicators, to avoid mutual interference between a plurality of domains, and protect load balancing between the domains. When the electronic device is located in the plurality of communicators, the multi-domain coordination module needs to manage establishment of an interaction channel between a plurality of G nodes corresponding to the plurality of communicators; maintain a neighboring G node list and basic information; coordinate resources of the plurality of domains; and perform joint positioning, mobility management, and load balancing.

The measurement management module is configured to measure a distance between the electronic device and another electronic device, a direction of the electronic device relative to the another electronic device, and the like based on received signal strength (received signal strength indicator, RSSI) and a preset algorithm. In addition, the measurement management module is further configured to: configure a measurement period, report a measurement event and a measurement result to the basic application layer, schedule a measurement resource, control a measurement power, and the like.

The 5G fusion module is configured to: establish a channel with a 5G remote management capability, and implement, based on an authentication mechanism, a device that has a cellular 5G remote control function. That is, the 5G fusion module enables each node device to have a capability of enabling a 5G edge core network to perceive control. For example, when the G node has a capability of being connected to a core network, and a T node does not have a capability of being connected to the core network, the 5G core network may deliver a control instruction to the T node through the G node, so that the T node can also be controlled by the 5G core network.

In this embodiment, the SparkLink access layer includes an SLB access layer and an SLE access layer. The SLB access layer and the SLE access layer each include a data link layer and a physical layer. The data link layer includes a link control layer and a media access layer. The link control layer provides a service for the basic service layer.

At a transmit end, the link control layer is configured to: perform necessary operations such as numbering (adding a sequence number SN), segmentation, encryption, and integrity protection on upper-layer service data (that is, data of the basic service layer), and send a generated logical channel profile data unit (logical channel profile data unit, LC PDU) to the media access layer. The media access layer performs multiplexing and encapsulation on different LC PDUs based on a quantity of scheduled resources, to generate a media access layer protocol data unit (media access profile data unit, MAC PDU).

At a receive end, the media access layer is responsible for decapsulating data and delivering the data to different logical channels. The link control layer may perform necessary operations such as decryption, reassembling, and sorting on the data, and sequentially deliver the service data to the basic service layer.

The physical layer is configured to provide a data transmission service to the data link layer, and specifically includes the following functions: Correctness verification of the transmission information and an indication to the data link layer, forward error correction (forward error correction, FEC) encoding/decoding of the transmission information, hybrid automatic repeat request (hybrid automatic repeat request, HARQ) soft combination, rate matching of transmitting the transmission information to a corresponding physical resource, mapping of encoded transmission information onto the corresponding physical resource, modulation and demodulation of physical layer control information and physical layer data information, synchronization of a frequency and a time, wireless feature measurement and an indication to the data link layer, multi-input and multi-output antenna processing, beamforming, radio-frequency processing, and the like.

Based on the wireless short-range communication protocol architecture provided in this embodiment, a service of the basic application layer may communicate with a peer end based on the SLB technology or the SLE technology based on different service requirements. The SLB technology is usually used to process a service that has a high-bandwidth transmission requirement, for example, a wireless projection service or a video call service. In a transmission process, a data throughput is usually high. The SLE technology is usually used to process a service that has a low-bandwidth transmission requirement, for example, an audio playing service of the wireless headset, and a control service of the mobile phone for a smart home device. In the transmission process, a data throughput is usually low, and a transmission rate and power consumption are also low.

In services provided by the application, some services support multilink transmission, and some services do not support multilink transmission. This is specifically determined based on a configuration of the service. For example, for a video transmission service (referred to as a video service), because a bandwidth required in a transmission process of a video stream is usually high, the video stream is usually configured to be transmitted at the SLB access layer, and cannot be transmitted at the SLE access layer. That is, the video service does not support multilink transmission.

In this embodiment, that a service supports multilink transmission means that the service supports data transmission at a plurality of different access layers, including: Data of the service is simultaneously and jointly transmitted at the plurality of different access layers, or data of the service is independently transmitted at any one of the plurality of different access layers. For example, when the service supports multilink data transmission at the SLB access layer and the SLE access layer, the data of the service may be simultaneously transmitted at the SLB access layer and the SLE access layer, or may be independently transmitted at the SLB access layer or the SLE access layer.

For a service (for example, an audio service) that supports multilink transmission, an embodiment provides a data transmission method, to improve a data transmission rate. The data transmission method provided in this embodiment includes the following two technical solutions: 1. Data is transmitted based on a transmission channel group. 2. Data is transmitted based on a mapping relationship between a service channel and different logical links. The following separately describes the two solutions.

### 1. Data is Transmitted Based on a Transmission Channel Group

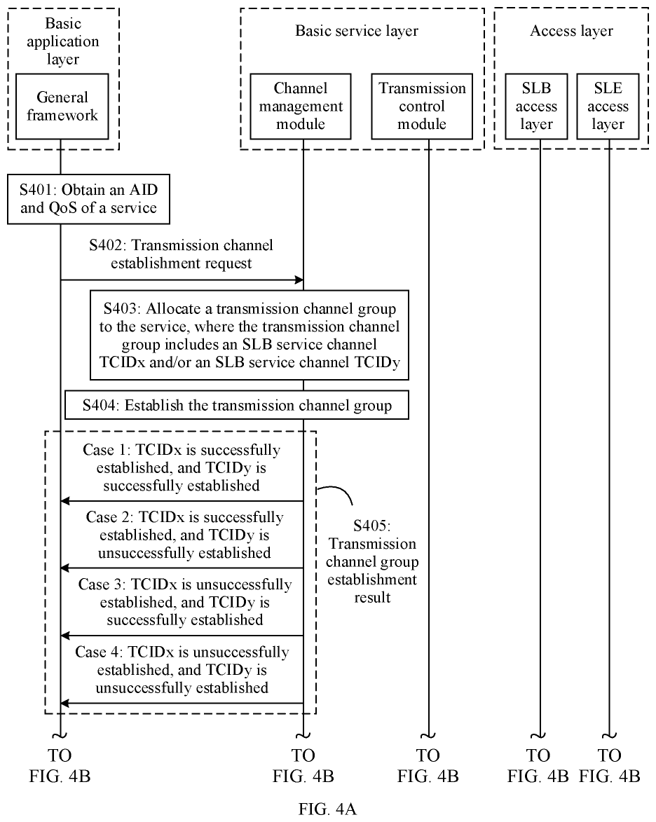

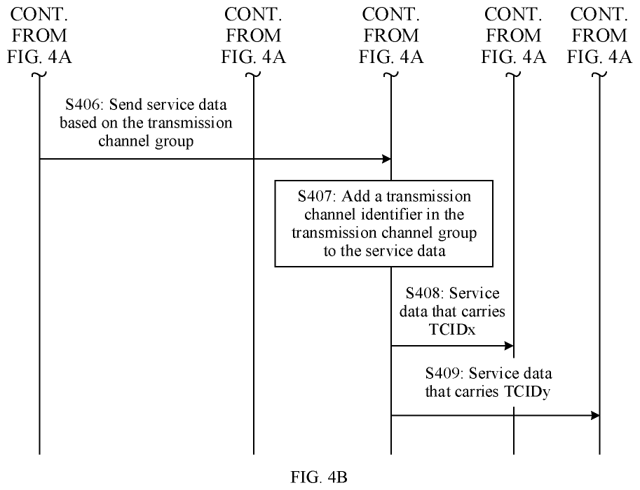

FIG. 4A and FIG. 4B are a flowchart of a data transmission method according to an embodiment of this application. FIG. 4A and FIG. 4B show a process in which a basic application layer and a basic service layer establish a transmission channel group for a service, and transmit data based on the transmission channel group. Steps S401 to S409 are specifically included.

S401: The basic application layer obtains an AID and QoS of a service.

An electronic device executes a corresponding service by running an application, and different applications have a same or different types of services, for example, an audio service, a video service, and a data transmission service. In addition, different services require different quality of service of data transmission. Some services require high fidelity, a low latency, and a high rate data in a data transmission process, and some services require low power consumption of the device in the data transmission process. Therefore, different applications configure different QoS for their different services. In a process of establishing the service, the application needs to send a service feature of the service to the basic application layer, including the AID and the QoS of the service. In addition, the basic application layer further allocates a port (port) to each service, and applies to the basic service layer for a service channel based on all of the AID, the QoS, and the port.

S402: The basic application layer sends a transmission channel establishment request to a channel management module of the basic service layer, where the transmission channel establishment request includes the AID, the QoS, and the port of the service.

The transmission channel establishment request is used to request the basic service layer to establish a transmission channel. The transmission channel may be an independent transmission channel, or may be a transmission channel group.

S403: When the service supports multilink transmission, the channel management module of the basic service layer allocates the transmission channel group to the service based on the transmission channel establishment request.

It should be noted that when the service does not support multilink transmission (that is, only supports transmission on one link), the channel management module allocates an independent service channel (for example, an SLB service channel or an SLE service channel) to the service based on only the AID, the QoS, and the port, and does not configure the transmission channel group for the service.

When the service supports multilink transmission, the channel management module allocates the transmission channel group to the service based on the AID, the QoS, and the port. The transmission channel group includes at least one service channel. For example, the transmission channel group includes a first service channel and/or a second service channel. The first service channel and the second service channel respectively correspond to a first logical link and a second logical link, and the first logical link and the second logical link respectively correspond to a first access layer and a second access layer that are different.

A wireless short-range communication protocol architecture provided in this embodiment of this application is used as an example. The channel management module may allocate, to the service, a transmission channel group corresponding to Group ID=gx. Service channels in the transmission channel group may be TCIDx and/or TCIDy. TCIDx is an SLB service channel, and the SLB service channel corresponds to an SLB access layer. TCIDy is an SLE service channel, and the SLE service channel corresponds to an SLE access layer.

It should be understood that the electronic device may simultaneously execute a plurality of services. When the channel management module allocates the transmission channel group to a new service, a link of the electronic device may be occupied by another service. Therefore, even if the service supports multilink transmission, the electronic device actually may not be able to provide a plurality of transmission links for the service. Therefore, a quantity of service channels in the transmission channel group specifically needs to be determined based on a service state and traffic on each link of the electronic device.

In some embodiments, when a current service state and current traffic of the SLB access layer and the SLE access layer both support to provide a service for the service, the channel management module separately configures an SLB service channel and an SLE service channel for the transmission channel group of the service.

In other words, when a service meets both the following conditions 1 and 2, the channel management module allocates a transmission channel group to the service, and configures both an SLB service channel and an SLE service channel in the transmission channel group.

Condition 1: A configuration of the service supports multilink transmission.

In some embodiments, for a video transmission service (that is, referred to as a video service), because a bandwidth required in a transmission process of a video stream is usually high, the video stream is usually configured to be transmitted at the SLB access layer, and cannot be transmitted at the SLE access layer. That is, a configuration of the video service does not support multilink transmission.

Condition 2: A resource of the SLB access layer and a resource of the SLE access layer both support to provide a service for the service.

For Condition 2, optionally, when the resource of the SLB access layer/SLE access layer does not support to add a new logical link, a high-priority service may preempt the resource of the SLB access layer/SLE access layer. In this embodiment of this application, adding a new logical link is to add the new logical link when an existing logical link is maintained.

For example, for the SLB access layer, a service 1 has currently occupied a part of the resource of the SLB access layer. When the electronic device has a to-be-processed service 2, if a remaining resource of the SLB access layer is insufficient to provide a service for the service 2, and a priority of the service 2 is higher than a priority of the service 1, the service 2 may preempt the resource of the SLB access layer.

For Condition 2, optionally, when the resource of the SLB access layer/SLE access layer supports to add a new logical link, a plurality of logical links may be established and retained simultaneously, or only a logical link of a high-priority service may be retained.

For example, for the SLB access layer, a service 1 has currently occupied a part of the resource of the SLB access layer. When the electronic device has a to-be-processed service 2, if a remaining resource of the SLB access layer is sufficient to provide a service for the service 2, and a priority of the service 2 is higher than a priority of the service 1. Then, the SLB access layer may maintain both a logical link of the service 1 and a logical link of the service 2, or may disconnect the logical link of the service 1 and establish the logical link of the service 2.

For another example, for the SLE access layer, a service 1 has currently occupied a part of the resource of the SLE access layer. When the electronic device has a to-be-processed service 2, if a remaining resource of the SLB access layer is sufficient to provide a service for the service 2, and a priority of the service 2 is lower than a priority of the service 1. Then, the SLB access layer may maintain both a logical link of the service 1 and a logical link of the service 2, or may maintain only the logical link of the service 1 and does not establish the logical link of the service 2.

In some other embodiments, if the SLB access layer is occupied by a high-priority service and link resources are insufficient, the channel management module configures only the SLE service channel TCIDy for the transmission channel group of the service.

In still some other embodiments, if the SLE access layer is occupied by a high-priority service and link resources are insufficient, the channel management module configures only the SLB service channel TCIDx for the transmission channel group of the service.

It should be understood that, that the channel management module allocates the transmission channel group to the service indicates that a group ID (for example, Group A, Group B, and Group C) of the transmission channel group and a TCID of a service channel in the transmission channel group are determined, and the transmission channel group and the service channel in the group are not successfully established. Specifically, the service channel needs to be established based on the following steps.

S404: The channel management module of the basic service layer establishes the transmission channel group.

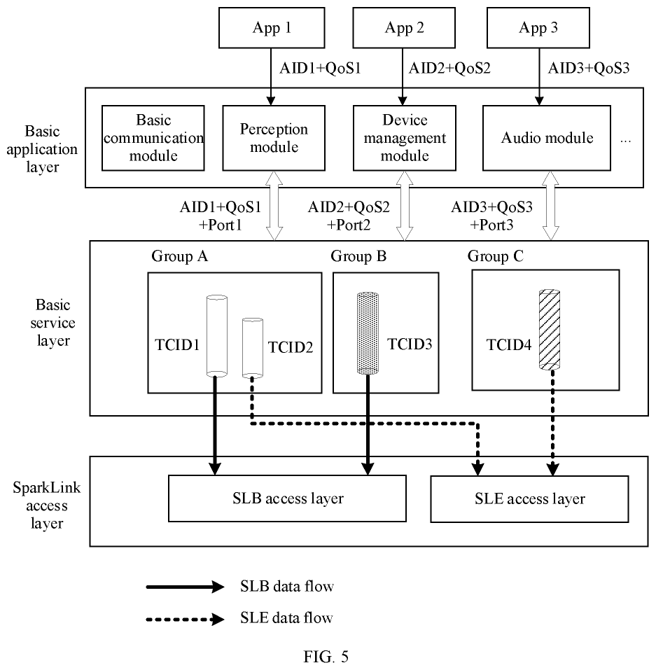

After determining the group ID, the basic service layer establishes the transmission channel group corresponding to the group ID. For example, as shown in FIG. 5, for Group A, the basic service layer needs to establish an SLB service channel and an SLE service channel for Group A. For Group B, the basic service layer only needs to establish an SLB service channel for Group B. For Group C, the basic service layer only needs to establish an SLE service channel for Group C.

It can be learned from the foregoing descriptions that the service channel needs to be established through negotiation on the control channel. In the wireless short-range communication protocol architecture provided in this embodiment of this application, the SparkLink access layer includes the SLB access layer and the SLE access layer. The SLB access layer corresponds to an SLB control channel at the basic service layer, and is configured to establish SLB service channels for different services. The SLE access layer corresponds to an SLE control channel at the basic service layer, and is configured to establish SLE service channels for different services.

In some embodiments, SLB and/or SLE control channels established for another service may have been at the basic service layer. In some other embodiments, no SLB and/or SLE control channel is established at the basic service layer. In this case, the basic application layer needs to notify the basic service layer to establish a new SLB and/or SLE control channel.

Therefore, when there is an SLB control channel at the basic service layer, the SLB service channel TCIDx is established between the basic service layer and the SLB access layer. When there is an SLE control channel at the basic service layer, the SLE service channel TCIDy is established between the basic service layer and the SLE access layer.

S405: The channel management module of the basic service layer sends a transmission channel group establishment result to the basic application layer.

It should be understood that although the basic service layer allocates a service channel to a transmission channel group of a current service, each service channel may be successfully established, or may be unsuccessfully established. For example, at the SLB access layer, if parameter (for example, the QoS) negotiation fails, message sending expires, or the SLB logical link is unsuccessfully established, the service channel TCIDx is unsuccessfully established. Similarly, at the SLE access layer, if parameter (for example, the QoS) negotiation fails, message sending expires, or the SLE logical link is unsuccessfully established, the service channel TCIDy is unsuccessfully established.

For example, the transmission channel group that needs to be established by the basic service layer includes TCIDx and TCIDy, a transmission channel group establishment result may include the following four cases.

Case 1: The service channels TCIDx and TCIDy are both successfully established, and the transmission channel group is successfully established.

Case 2: The service channel TCIDx is successfully established, the service channel TCIDy is unsuccessfully established, and the transmission channel group is successfully established.

Case 3: The service channel TCIDx is unsuccessfully established, the service channel TCIDy is successfully established, and the transmission channel group is successfully established.

Case 4: The service channels TCIDx and TCIDy are both unsuccessfully established, and the transmission channel group is unsuccessfully established.

After the transmission channel group is established, the channel management module sends an identifier (for example, Group ID=gx) of the successfully established transmission channel group to the basic application layer.

S406: If the transmission channel group is successfully established, the basic application layer sends service data corresponding to the service to the transmission control module based on the transmission channel group.

After receiving the service data sent by the application, the basic application layer adds a port number (port) of the service to the service data. The port is mapped onto all service channels in the transmission channel group. Then, the service data is sent to the transmission control module of the basic service layer.

When the service channels in the transmission channel group include TCIDx and TCIDy, the port is simultaneously mapped onto TCIDx and TCIDy. When the service channels in the transmission channel group include only TCIDx, the port is mapped onto only TCIDx. When the service channels in the transmission channel group include only TCIDy, the port is mapped onto only TCIDy.

S407: The transmission control module adds a transmission channel identifier in the transmission channel group to the service data.

Specifically, the transmission control module adds, based on a mapping relationship between the port and the service channel, a corresponding service channel identifier to the service data that carries the port. For example, when the port is mapped onto only TCIDx, the transmission control module adds a TCIDx identifier to the service data that carries the port. When the port is mapped onto only TCIDy, the transmission control module adds a TCIDy identifier to the service data that carries the port. When the transmission channel group includes both TCIDx and TCIDy, the TCID is added to the service data based on a transmission policy. The transmission policy may control the transmission control module to transmit data through one or more service channels in the transmission channel group.

In this embodiment, the transmission policy may be offloading transmission, or may be redundant transmission. Offloading transmission means that one part of all service data of a current service is transmitted through the SLB service channel, and the other part is transmitted through the SLE service channel. The two parts of service data are different. Redundant transmission means that one part of all service data of a current service is transmitted through the SLB service channel, and the other part is transmitted through the SLE service channel. The two parts of service data are completely the same or partially the same. For example, when the transmission control module transmits the service data in an offloading manner, TCIDx is added to one part of the data to be transmitted through the SLB service channel, TCIDy is added to the other part of the data to be transmitted through the SLE service channel, and the two parts of the service data are different.

During offloading transmission, a proportion of service data at the SLB access layer and service data at the SLE access layer may be determined based on a bandwidth, a state (for example, video definition) of an existing service, and traffic of the SLB access layer and traffic of the SLE access layer.

In addition, it should be noted that when the transmission control module transmits the service data through a plurality of links, transmission cannot be performed in a basic mode or a transparent transmission mode, because in the basic mode, during data transmission, grouping or retransmission is not performed at the basic service layer, and the peer end does not need to give an acknowledgement (ack). The basic service layer does not perform any processing on data packets in the transparent transmission mode. The two modes do not support to add a sequence number (sequence number, SN) to the service data. Therefore, after receiving service data without an SN, the peer device cannot sort the service data, leading data disorder.

S408: The transmission control module sends, to the SLB access layer, the service data that carries the SLB service channel identifier TCIDx, to send the service data to the peer device at the SLB access layer.

S409: The transmission control module sends, to the SLE access layer, the service data that carries the SLE service channel identifier TCIDy, to send the service data to the peer device at the SLE access layer.

In conclusion, in this embodiment of this application, a transmission channel group including a plurality of channels supports to transmit different data frames at a plurality of different access layers (which are respectively the SLB access layer and the SLE access layer), and also supports redundant transmission, to improve a transmission rate of the service data, reduce a latency of the service data, and improve reliability of the service data. In addition, in a data transmission process, even if a link is faulty, the transmission channel group does not need to be reconfigured, and the service data may still be transmitted.

In a process of transmitting the service data based on the transmission channel group, the service may be switched between the SLB access layer and the SLE access layer based on a requirement of the electronic device, including (1) switching the service data from the SLE access layer to the SLB access layer for transmission; and (2) switching the service data from the SLB access layer to the SLE access layer for transmission. The following separately provides descriptions.

(1) Switch Service Data from an SLE Access Layer to an SLB Access Layer for Transmission

It can be learned from the foregoing descriptions that, although a configuration of a specific service supports multilink transmission, because the SLB access layer is occupied by a high-priority service and remaining resources of the SLB access layer are insufficient to provide a service for the service, a transmission channel group established by a basic service layer for the service includes only one SLE service channel, and the service transmits service data to a peer end through only the SLE service channel and the SLE access layer. However, when a QoS requirement of the service is improved, a current SLE service channel may be unable to meet a service requirement. Alternatively, after the QoS requirement of the service does not change, but a data transmission capability of an electronic device is improved, transmission quality of the service data cannot be improved if the service data is still transmitted through the SLE service channel. Therefore, in an embodiment of this application, when the SLB access layer recovers to be able to provide a service for the service, the service data may be switched from the SLE access layer to the SLB access layer for transmission.

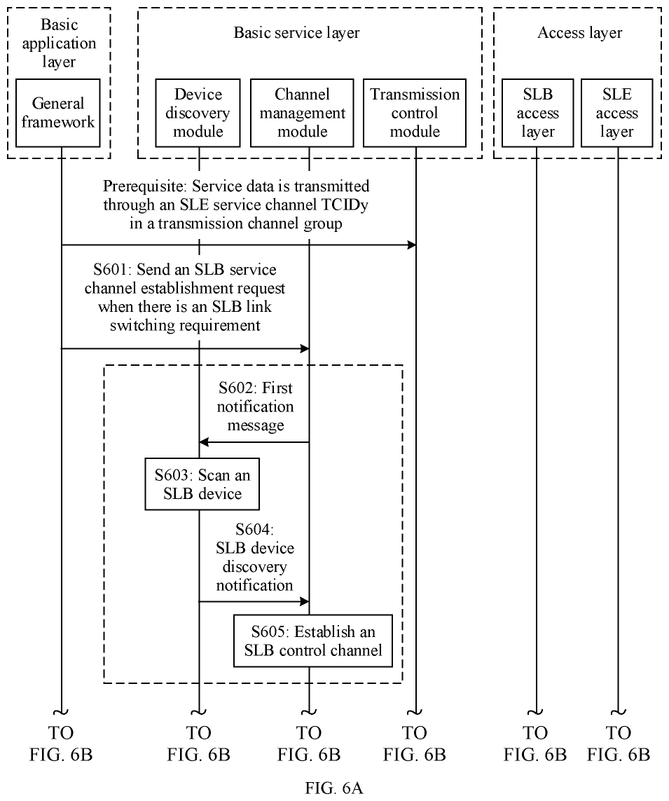

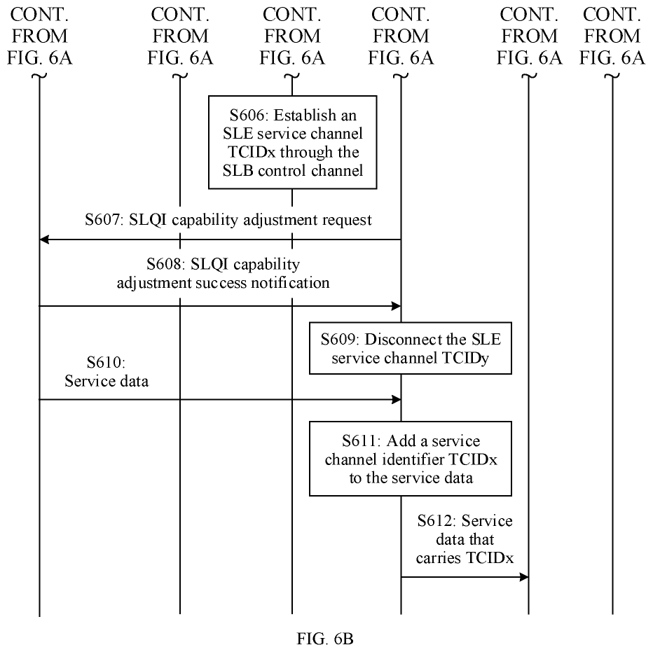

FIG. 6A and FIG. 6B are a flowchart of a data transmission method according to another embodiment of this application, and relates to a process of switching service data from an SLE access layer to an SLB access layer for transmission.

S601: In a process in which a basic application layer transmits service data through an SLE service channel TCIDy in a transmission channel group, when there is an SLB switching requirement, the basic application layer sends an SLB service channel establishment request to a channel management module of a basic service layer.

In some embodiments, the SLB switching requirement is that a QoS requirement of a current service is improved. For example, in a process in which a mobile phone controls, through an SLE service channel, a wireless headset to play standard-definition audio, if a user switches quality of the audio from standard-definition to high-definition on a mobile phone side, a QoS requirement of an audio playing service is improved, and an application sends a new QoS requirement to the basic application layer. After the basic application layer receives the new QoS requirement, when the new QoS requirement is higher than an original QoS requirement, if the current service can be simultaneously transmitted at the SLB access layer and the SLE access layer, the basic application layer requests a new SLB service channel TCIDx added by the channel management module to the transmission channel group.

In some other embodiments, the SLB switching requirement is to improve a capability that can be provided by the basic service layer (referred to as a SparkLink service requirement in this embodiment, and may be represented by a SparkLink quality of service index (SparkLink QoS index, SLQI)). For example, when the mobile phone controls a wireless headset to play high-definition audio, a QoS requirement of the high-definition audio playing service is high. However, because an SLB access layer of the basic service layer is occupied by another service, or the like, the basic service layer cannot provide an SLB access layer with a high SparkLink quality of service (which may be represented by SLQI-A) for the high-definition audio playing service, but provides an SLE access layer with a low SLQI (which may be represented by SLQI-B) for the service. After the application agrees on SLQI-B, the application transmits service data at the SLE access layer.

Because a bandwidth of the SLE access layer is low, congestion may occur in a transmission process of a media stream of the high-definition audio, leading to poor audio playing quality. Therefore, in this embodiment, in a process of executing the high-definition audio playing service, if a service that previously occupies the SLB access layer ends, the SLB access layer is idle, and the channel management module establishes the SLB service channel for the service, and switches the service from the SLE access layer to the SLB access layer, to transmit service data at a high-bandwidth SLB access layer, improve a data transmission rate, and improve playing quality of the high-definition audio.

In some other embodiments, the SLB switching requirement is that a QoS management module detects that SLE air interface quality is poor, and a bit error rate is high.

It should be noted that QoS is quality of service sent by the application, and parameters in the QoS define quality of service expected by the service. The SLQI is quality of service of a communication link that can be actually provided by the basic service layer for the service. One protocol architecture may simultaneously process a plurality of services, and remaining transmission resources are insufficient. Therefore, the basic service layer sometimes may meet a service expectation, and sometimes cannot meet a service expectation. Therefore, after obtaining QoS of a service, the basic service layer needs to negotiate with a peer device based on a remaining transmission resource, to determine actual quality of service that can be provided to the service, that is, determine the SLQI. Therefore, the SLQI may be the same as the QoS, may be worse than quality of service defined by the QoS, or may be better than quality of service defined by the QoS.

In some cases, there is currently an SLB control channel at the basic service layer. The basic service layer may directly perform step S605 to establish the SLB service channel based on the SLB control channel. In some other cases, there is currently no SLB control channel at the basic service layer. Therefore, the basic service layer needs to first establish the SLB control channel. For a specific establishment process, refer to steps S602 to S605.

S602: The channel management module of the basic service layer sends a first notification message to a device discovery module, where the first notification message indicates the device discovery module to scan an SLB device.

For example, the channel management module may determine, based on a factor such as whether the SLB access layer has a high-priority service or whether a remaining resource of the SLB access layer supports the service, whether to indicate the device discovery module to scan the SLB device.

S603: The device discovery module scans the SLB device.

S604: The device discovery module sends an SLB device discovery notification to the channel management module.

In this embodiment, the SLB device discovery notification indicates that the device discovery module finds that a peer device corresponding to the current service supports an SLB communication function.

S605: The channel management module establishes a default SLB logical link with the peer device corresponding to the current service, to form an SLB control channel.

It should be noted that the SLB control channel is a default channel (or may be understood as a default channel) on the default SLB logical link. After the default SLB logical link is established, the basic service layer automatically generates the SLB control channel, and an identifier of the SLB control channel is also a default identifier.

It should be noted that in this embodiment, other than the default logical link, all logical links that are not otherwise specified are dedicated logical links, and are used to process a specific communication service.

S606: The channel management module establishes an SLB service channel TCIDx through the SLB control channel, where TCIDx and TCIDy belong to a same transmission channel group.

It should be noted that the SLB control channel is a basis for establishing different SLB service channels between devices. In a process of establishing the service channel between devices, two electronic devices negotiate, on the SLB control channel, about parameters required for establishing the SLB service channel.

S607: The channel management module sends an SLQI capability adjustment request to the basic application layer.

In some embodiments, after the channel management module establishes a new SLB service channel for the service, data transmission quality actually provided by the channel management module to the service also changes. For example, data transmission quality SLQI-B provided by the SLE access layer changes to data transmission quality SLQI-A that can be provided by the SLB access layer. Therefore, the channel management module needs to send the SLQI capability adjustment request to the basic application layer, to request to adjust, to SLQI-A, the SLQI provided for the service.

S608: After the basic application layer agrees to the SLQI capability adjustment request, the basic application layer sends an SLQI capability adjustment complete notification to the channel management module.

In some embodiments, after receiving the SLQI capability adjustment request, the basic application layer needs to send the request to an application of the service, to query whether the application agrees to transmit the service data in a case of a data transmission capability corresponding to the SLQI. Only after the application agrees, the basic application layer can send the SLQI capability adjustment complete notification to the channel management module.

In some other embodiments, after receiving the SLQI capability adjustment request, the basic application layer locally determines whether to agree to transmit the service data in a case of the data transmission capability corresponding to the SLQI, and does not need to query the application.

S609: The channel management module disconnects the SLE service channel TCIDy.

It should be noted that S609 is an optional step, and the electronic device may not perform S609 after performing S608. To be specific, after the SLB service channel TCIDx is successfully established, the channel management module may not disconnect the SLE service channel TCIDy, so that there are both TCIDx and TCIDy in the transmission channel group.

S610: The basic application layer sends the service data to the transmission control module, where the service data carries a port, and the port is mapped onto all service channels in the transmission channel group.

In addition, it should be noted that a sequence of S609 and S610 is not limited in this embodiment. The transmission control module may perform S609 before S610, or may perform S609 after S610.

S611: The transmission control module adds a service channel identifier TCIDx corresponding to the port to the service data.

S612: The transmission control module sends, to the SLB access layer, the service data that carries TCIDx.

It should be understood that, although the service data of the application is switched from the SLB service channel to the SLE service channel for transmission, the service is still in an original transmission channel group.

According to the method provided in this embodiment of this application, in a process of performing SLE communication between the electronic device and the peer device corresponding to the current service, the electronic device can switch the service data from the SLE access layer to the SLB access layer for transmission, to improve a data transmission rate between devices. In addition, in a link switching process, a user is imperceptible, to help improve user experience.

(2) Switch Service Data from an SLB Access Layer to an SLE Access Layer for Transmission

It can be learned from the foregoing descriptions that, although a configuration of a specific service supports multilink transmission, because the SLE access layer is occupied by a high-priority service and remaining resources of the SLE access layer are insufficient to provide a service for the service, a transmission channel group established by a basic service layer for the service includes only one SLB service channel, and the service transmits service data to a peer end through only the SLB service channel and the SLB access layer. Because power consumption of the SLB access layer is large, and a battery power of a device is lost too fast due to long time use, when an electronic device has a low power consumption requirement, and the SLE access layer is recovered to be able to provide a service for the service, the basic service layer may switch service data of the service from the SLB access layer to the SLE access layer for transmission, to reduce power consumption of the device and improve device use duration.

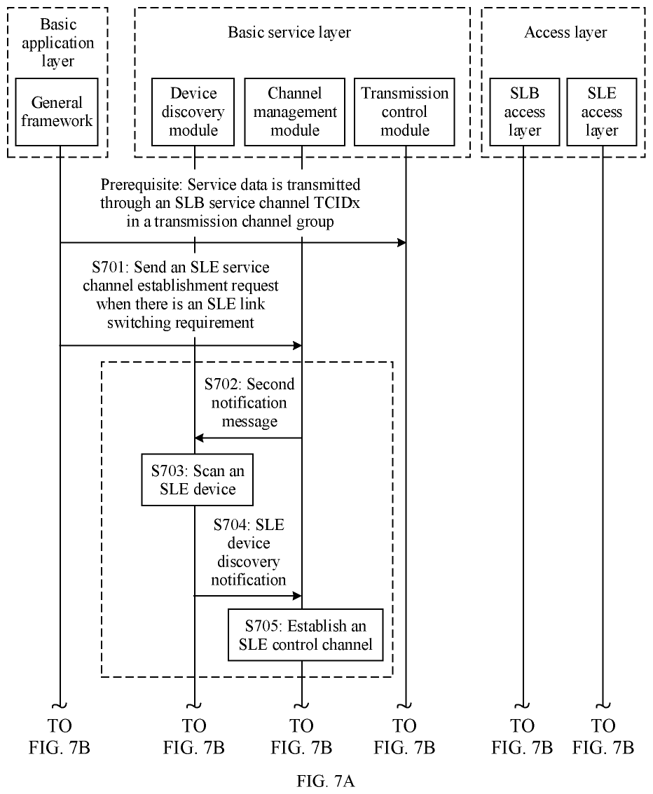

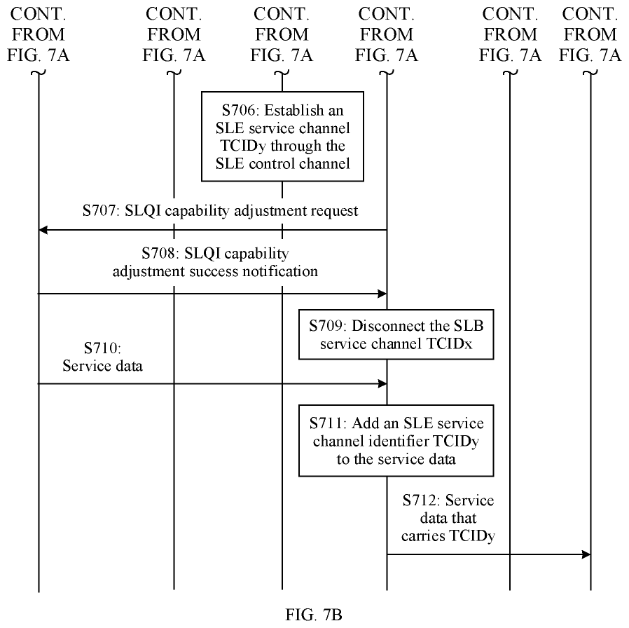

FIG. 7A and FIG. 7B are a flowchart of a data transmission method according to still another embodiment of this application, and relates to a process of switching service data from an SLB access layer to an SLE access layer for transmission.

S701: In a process in which a basic application layer transmits service data through an SLB service channel TCIDx in a transmission channel group, when there is an SLE switching requirement, the basic application layer sends an SLE service channel establishment request to a channel management module of a basic service layer.

For example, the SLE switching requirement is that a battery power is less than a preset value (for example, 20% of a full charge power), or an electronic device is switched to a power saving mode.

In some cases, there is currently an SLE control channel at the basic service layer. The basic service layer may directly perform step S706 to establish an SLE service channel based on the SLE control channel. In some other cases, there is currently no SLE control channel at the basic service layer. Therefore, the basic service layer needs to establish an SLE control channel, and then perform step S706 to establish an SLE service channel. For a specific establishment process, refer to steps S702 to S705.

S702: The channel management module of the basic service layer sends a second notification message to a device discovery module, where the second notification message indicates the device discovery module to scan an SLE device.

For example, the channel management module may determine, based on a factor such as whether the SLE access layer has a high-priority service or whether a remaining resource of the SLE access layer supports the service, whether to indicate the device discovery module to scan the SLE device.

S703: The device discovery module scans the SLE device.

S704: The device discovery module sends an SLE device discovery notification to the channel management module.

In this embodiment, the SLE device discovery notification indicates that the device discovery module finds that a peer device corresponding to a current service supports an SLE communication function.

S705: The channel management module establishes an SLE logical link with the peer device corresponding to the current service, to form an SLE control channel.

It should be noted that the SLE control channel is a default channel (or may be understood as a default channel) on the SLE logical link. After the SLE logical link is established, the basic service layer automatically generates the SLE control channel, and an identifier of the SLE control channel is also a default identifier.

S706: The channel management module establishes an SLE service channel TCIDy through the SLE control channel, where TCIDx and TCIDy belong to a same transmission channel group.

It should be noted that the SLE control channel is a basis for establishing different SLE service channels between devices. In a process of establishing the service channel between devices, two devices negotiate, on the SLE control channel, about parameters required for establishing the SLE service channel.

S707: The channel management module sends an SLQI capability adjustment request to the basic application layer.

After the channel management module establishes a new SLB service channel for the service, data transmission quality actually provided by the channel management module to the service also changes. To be specific, data transmission quality SLQI-A that can be provided by the SLB access layer changes to data transmission quality SLQI-B that can be provided by the SLE access layer. Therefore, the channel management module needs to send an SLQI capability adjustment request to the basic application layer, to request to adjust the SLQI provided for the service to SLQI-B.

S708: After the basic application layer agrees to the SLQI capability adjustment request, the basic application layer sends an SLQI capability adjustment complete notification to the channel management module. For details, refer to S608. Details are not described herein in this embodiment.

S709: The channel management module disconnects the SLB service channel TCIDx.

It should be noted that S709 is an optional step, and the electronic device may not perform S709 after performing S708. To be specific, after the SLE service channel TCIDy is successfully established, the channel management module may not disconnect the SLB service channel TCIDx, so that there are both TCIDx and TCIDy in the transmission channel group.

S710: The basic application layer sends the service data to the transmission control module, where the service data carries a port, and the port is mapped onto all service channels in the transmission channel group.

It should be understood that, although the service data of the application is switched from the SLB service channel to the SLE service channel for transmission, the service is still in an original transmission channel group.

In addition, it should be noted that a sequence of S708 and S709 is not limited in this embodiment. The transmission control module may perform S708 before S709, or may perform S708 after S709.

S711: The transmission control module adds an SLE service channel identifier TCIDy corresponding to the port to the service data.

S712: The transmission control module sends, to the SLE access layer, the service data that carries TCIDy.

According to the method provided in this embodiment of this application, in a process in which the electronic device and the peer device perform communication at the SLB access layer, when the electronic device has a low power consumption requirement, the electronic device can switch the service data from the SLB access layer to the SLE access layer for transmission, to reduce device power consumption and improve device use duration. In addition, in a link switching process, a user is imperceptible, to help improve user experience.

### 2. Transmit Data Based on a Mapping Relationship Between a Service Channel and Different Logical Links

It should be noted that, after the first device and the second device perform a device discovery and connection, a default SLB logical link is established between an SLB access layer of the first device and an SLB access layer of the second device, and the default SLB logical link corresponds to a default SLB control channel and a default SLB service management channel at the basic service layer. In addition, a default SLE logical link is also established between the SLE access layer of the first device and the SLE access layer of the second device, and the default SLE logical link corresponds to a default SLE control channel and a default SLE service management channel at the basic service layer.

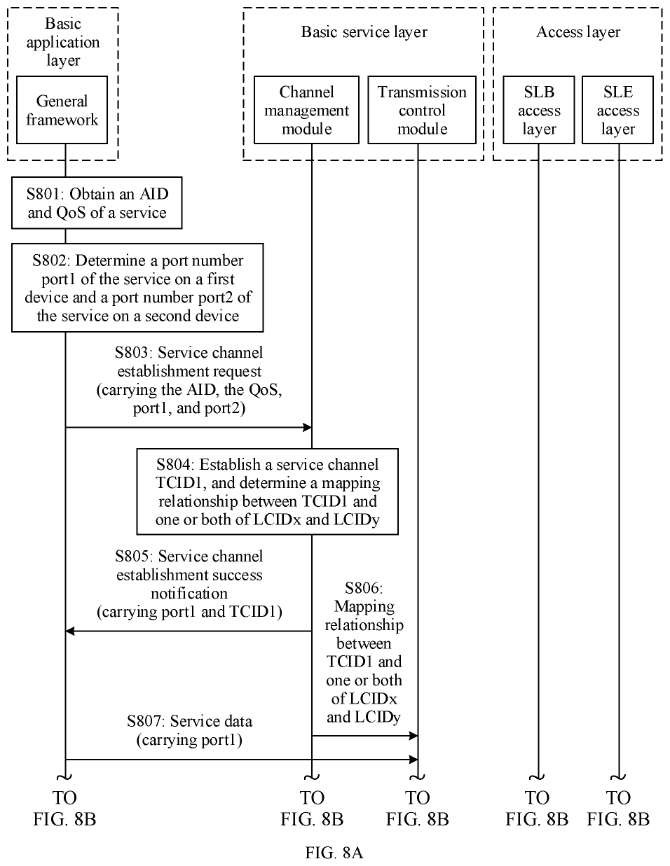

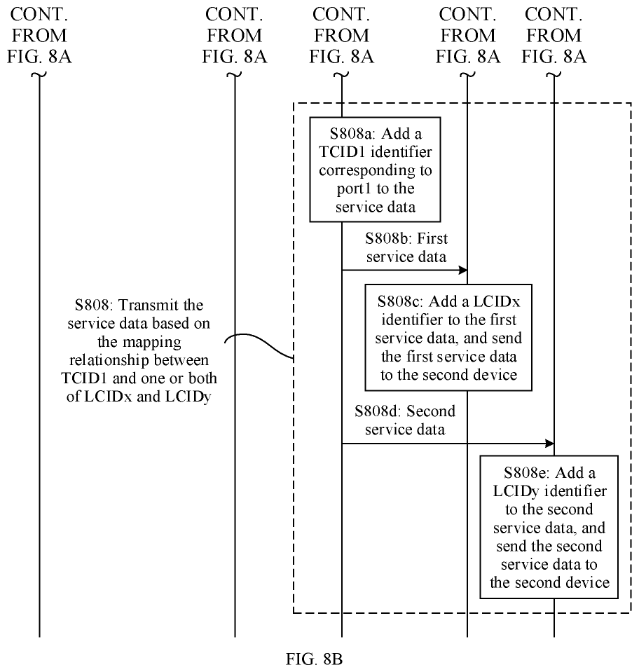

After a connection is established between the first device and the second device, a communication service may be processed based on a user requirement. For example, the first device shares a picture, a file, audio, or a video with the second device based on the user requirement. The following describes, with reference to FIG. 8A and FIG. 8B, a process in which a first device transmits service data to a second device.

FIG. 8A and FIG. 8B are a flowchart of a data transmission method according to an embodiment of this application, and shows a process in which a first device transmits data to a second device based on a one-to-two mapping relationship between a service channel and a logical link. In this embodiment, steps performed by the first device specifically include S801 to S808.

S801: A basic application layer obtains an AID and QoS of a service.

In a process of establishing the service (specifically, a communication service), an application needs to send a service feature of the service to the basic application layer. The service feature includes the AID and the QoS of the service.

S802: The basic application layer determines a port number (port)1 of the service on the first device and a port number (port)2 of the service on the second device.

After obtaining the AID and the QoS of the service, a basic application layer of the first device negotiate with a basic service layer of the second device through a default SLB service management channel or a default SLE service management channel, to determine the port numbers of the service on the two devices. In an example, the first device and the second device determine the port number of the service on the first device as port1, and determine the port number of the service on the second device as port2.

S803: The basic application layer sends a service channel establishment request to a channel management module of the basic service layer, where the service channel establishment request carries the AID, the QoS, port1, and port2 of the service.

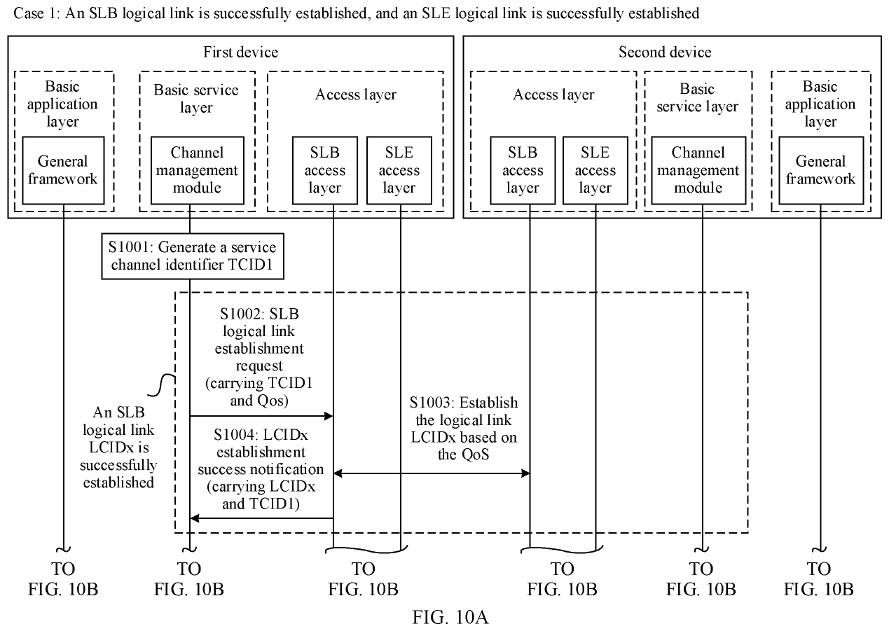

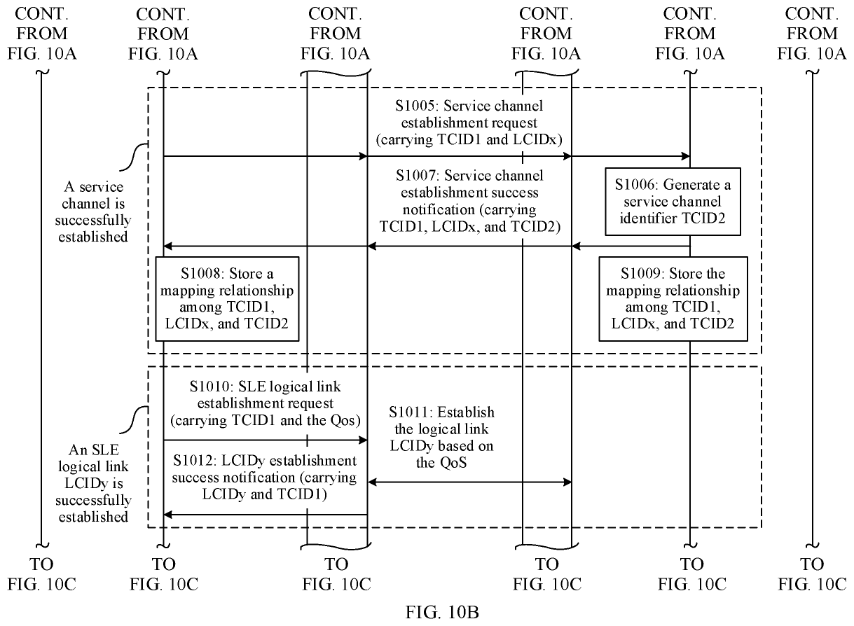

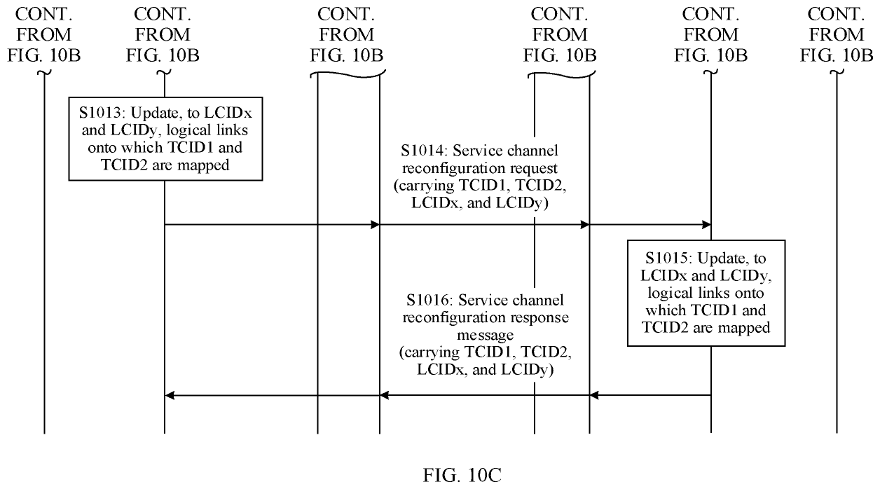

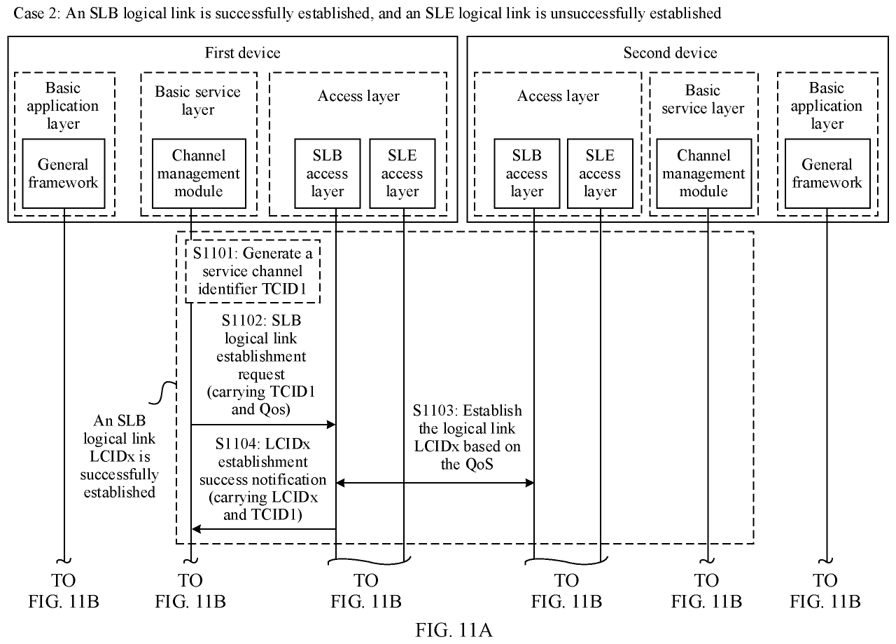

S804: The channel management module establishes a service channel TCID1, and determines a mapping relationship between TCID1 and one or both of an SLB logical link LCIDx and an SLE logical link LCIDy. For details of this step, refer to FIG. 10A to FIG. 10C to FIG. 13.

In this embodiment, the mapping relationship between TCID1 and both of LCIDx and LCIDy includes:

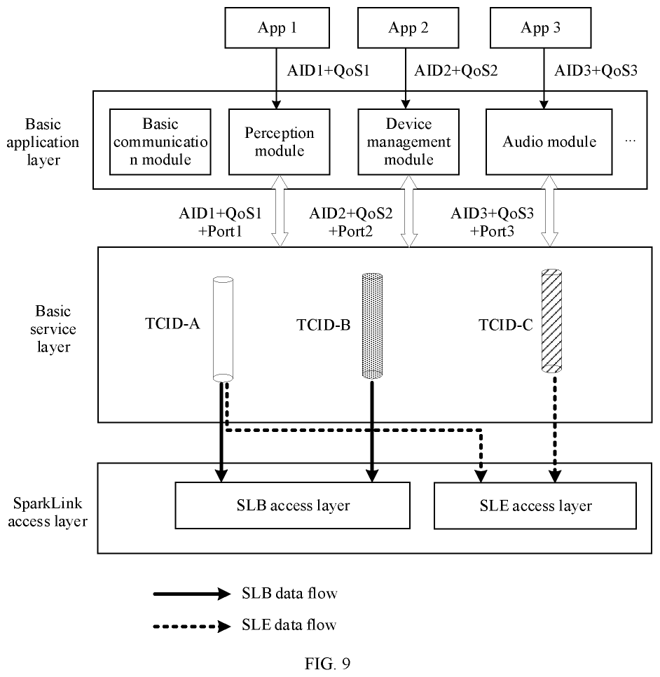

First mapping relationship: TCID1 is mapped onto only LCIDx (refer to a mapping relationship between TCID-B and the SLB logical link in FIG. 9). Based on the first mapping relationship, the first device may transmit service data on TCID1 to the second device through LCIDx.

Second mapping relationship: TCID1 is mapped onto only LCIDy (refer to a mapping relationship between TCID-C and the SLE logical link in FIG. 9). Based on the second mapping relationship, the first device may transmit service data on TCID1 to the second device through LCIDy.

Third mapping relationship: TCID1 is simultaneously mapped onto LCIDx and LCIDy (refer to a mapping relationship between TCID-A and both of the SLB logical link and the SLE logical link in FIG. 9). Based on the third mapping relationship, the first device may transmit the service data on the TCID1 to the second device through LCIDx, or may transmit the service data on the TCID1 to the second device through LCIDy.

S805. The channel management module sends a service channel establishment success notification to the basic application layer, so as to notify the basic application layer that the service channel TCID1 corresponding to the port1 is successfully established.

S806: The channel management module sends the mapping relationship between TCID1 and one or both of LCIDx and LCIDy to a transmission control module.

It should be noted that the channel management module may perform S805 before S806, or may perform S805 after S806. This is not limited in this embodiment.

S807: The basic application layer sends service data to the transmission control module, where the service data carries port1.

A first device is used as an example. When a first device processes a communication service, a basic application layer of the first device usually allocates a port number (port) to each communication service. Different communication services may be transmitted through a same service channel, or may be transmitted through different service channels. When one service channel processes service data corresponding to only one port, the port is separately mapped onto the service channel. For example, port1 is separately mapped onto TCID1. Based on this, when sending the service data corresponding to the port to the basic service layer, the basic application layer may or may not add an identifier of port1. When one service channel simultaneously processes service data corresponding to a plurality of ports, the plurality of ports are simultaneously mapped onto one service channel. For example, port1, port2, and port3 are simultaneously mapped onto TCID1. When sending the service data to the basic service layer, the basic application layer needs to add a port number corresponding to the service to the service data. If no port number corresponding to the service is added to the service data, the basic service layer cannot distinguish between service data.

S808: The transmission control module adds a TCID1 identifier to the service data based on a mapping relationship between port1 and the TCID1, and controls transmission of the service data based on the mapping relationship between TCID1 and one or both of LCIDx and LCIDy and a transmission policy.

When TCID1 is mapped onto LCIDx, the transmission control module sends the service data to the SLB access layer, so that the SLB access layer adds an LCIDx identifier to the service data, and sends the service data to the second device.

When TCID1 is mapped onto LCIDy, the transmission control module sends the service data to the SLE access layer, so that the SLE access layer adds an LCIDy identifier to the service data, and sends the service data to the second device.

When TCID1 is simultaneously mapped onto LCIDx and LCIDy, the transmission control module transmits the service data based on the mapping relationship and the transmission policy in steps S808a to S808e.

S808a: The transmission control module adds the TCID1 identifier to the service data based on a mapping relationship between port1 and TCID1. The service data may be divided into first service data and second service data.

S808b: The transmission control module sends the first service data to the SLB access layer.

S808c: The SLB access layer adds the LCIDx identifier to the first service data, and sends the first service data to the second device.

S808d: The transmission control module sends the second service data to the SLE access layer.

S808e: The SLE access layer adds the LCIDy identifier to the second service data, and sends the second service data to the second device.

In this embodiment, the transmission policy may alternatively be offloading transmission or redundant transmission. Offloading transmission means that one part (that is, the first service data) of all service data of a current service is transmitted through LCIDx, and the other part (that is, the second service data) is transmitted through LCIDy. The two parts of service data are different. Redundant transmission means that the first service data is transmitted through LCIDx, and the second service data is transmitted through LCIDy. The two parts of service data are completely the same or partially the same.

During offloading transmission, a proportion of service data on LCIDx and service data on LCIDy may be determined by the transmission control module based on a bandwidth, a state (for example, video definition) of an existing service, and traffic of the SLB access layer and traffic of the SLE access layer.

In addition, it should be noted that when the transmission control module simultaneously transmits the service data through LCIDx and LCIDy, transmission cannot be performed in a basic mode or a transparent transmission mode, because in the basic mode, during data transmission, grouping or retransmission is not performed at the basic service layer, and the peer end does not need to give an acknowledgement (ack). The basic service layer does not perform any processing on data packets in the transparent transmission mode. The two modes do not support to add a sequence number (sequence number, SN) to the service data. Therefore, after receiving service data without an SN, the peer device cannot sort the service data, leading data disorder.

In conclusion, in the data transmission method provided in this embodiment of this application, one service channel may be simultaneously mapped onto the SLB logical link and the SLE logical link. Therefore, in the method provided in this embodiment, the service data can be simultaneously transmitted at the SLB access layer and the SLE access layer, to improve a transmission rate of the service data, reduce a latency of the service data, and improve reliability of the service data. In addition, in a data transmission process, even if one logical link is faulty, the service data can still be transmitted without requiring an upper-layer application to control a protocol architecture to re-establish a logical link.

The following describes a process in which the channel management module establishes the service channel TCID1 and determines the mapping relationship between TCID1 and one or both of LCIDx and LCIDy in S804.

Before establishing the service channel, the channel management module first needs to request the access layer to establish at least one logical link. Subsequently, the channel management module can establish service channel corresponding to the logical link at the basic service layer. In this embodiment, the logical link may be the SLB logical link LCIDx and/or the SLE logical link LCIDy.

Optionally, when a remaining resource of the SLB access layer supports to provide a service for the communication service, the SLB access layer establishes LCIDx for the communication service, including: When the remaining resource of the SLB access layer supports to add a new logical link, the SLB logical link is established for the service regardless of whether a priority of the service is higher than a priority of an existing service at the SLB access layer. However, when the remaining resource of the SLB access layer does not support to add a new logical link, only when a priority of the service is higher than a priority of an existing service at the SLB access layer, a logical link of the existing service is disconnected, and an SLB logical link is established for the high-priority service.

In a possible implementation, when the remaining resource of the SLB access layer does not support to add a new logical link, the SLB access layer may not establish an SLB logical link for a newly added service even if a priority of the newly added service is higher than a priority of an existing service at the SLB access layer.

Optionally, for an SLE logical link establishment condition, refer to an SLB logical link establishment condition. Details are not described herein again in this embodiment.

In a logical link establishment process, affected by a factor such as quality of an access layer and QoS negotiation, a result of establishing LCIDx and LCIDy may include Case 1 to Case 4.

Case 1: The SLB logical link LCIDx is successfully established, and the SLE logical link LCIDy is successfully established.

Case 2: The SLB logical link LCIDx is successfully established, and the SLE logical link LCIDy is unsuccessfully established.

Case 3: The SLB logical link LCIDx is unsuccessfully established, and the SLE logical link LCIDy is successfully established.

Case 4: The SLB logical link LCIDx is unsuccessfully established, and the SLE logical link LCIDy is unsuccessfully established.

The following separately describes Case 1 to Case 4 and a service channel establishment process in each case.

It should be noted that in the following embodiments, example descriptions of a process of establishing LCIDx, LCIDy, and TCID1 are provided, and a sequence of establishing LCIDx and LCIDy is not limited. In addition, an occasion of establishing TCID1 and a target logical link corresponding to TCID1 in a process of establishing TCID1 are not limited in the following embodiments. After the at least one logical link is successfully established, the first device may negotiate with the second device through a default control channel corresponding to the logical link, to establish a service channel.

Case 1: An SLB logical link LCIDx is successfully established, and an SLE logical link LCIDy is successfully established.

FIG. 10A to FIG. 10C show a procedure of establishing a logical link and a service channel according to an embodiment of this application. Specifically, steps S1001 to S1016 are included, and may be grouped into the following four parts.

### (1) An SLB Logical Link LCIDx is Successfully Established

S1001: A channel management module of a first device generates a service channel identifier TCID1.

S1002: The channel management module of the first device sends an SLB logical link establishment request to an SLB access layer of the first device, where the request carries TCID1 and QoS of a service.

S1003: The SLB access layer of the first device and an SLB access layer of a second device perform QoS negotiation, to establish an SLB logical link LCIDx.

S1004: After LCIDx is successfully established, the SLB access layer of the first device sends an LCIDx establishment success notification to the channel management module of the first device.

### (2) A Service Channel is Successfully Established

S1005: The channel management module of the first device sends a service channel establishment request to a channel management module of the second device through an SLB control channel, where the service channel establishment request carries TCID1 and LCIDx.

S1006: The channel management module of the second device generates a service channel identifier TCID2.

It should be noted that a service channel is a concept at a basic service layer. In a process of processing a service, a basic service layer of the first device needs to set a first service channel (for example, TCID1) for the service, and a basic service layer of the second device needs to set a second service channel (for example, TCID2) for the service. An identifier of the first service channel and an identifier of the second service channel may be the same or different. The first device and the second device transmit service data corresponding to the service based on a correspondence between TCID1, LCIDx, and TCID2. Therefore, after receiving the service channel establishment request sent by the first device, the channel management module of the second device first needs to locally generate an identifier TCID2 of the second service channel.

In addition, after generating the service channel identifier TCID2, the second device further needs to establish a mapping relationship between port2 and TCID2, and send the mapping relationship to a basic application layer of the second device.

S1007: The channel management module of the second device sends a service channel establishment success notification to the channel management module of the first device through the SLB control channel.

The service channel establishment success notification includes the mapping relationship among TCID1, LCIDx, and TCID2, and is used to notify that a service channel between the first device and the second device is successfully established.

After the service channel TCID1 is successfully established, the channel management module further needs to establish a mapping relationship between port1 and TCID1, and send the mapping relationship to the basic application layer.

S1008: The channel management module of the first device stores the mapping relationship among TCID1, LCIDx, and TCID2.

The mapping relationship among TCID1, LCIDx, and TCID2 is that TCID1 corresponds to TCID2, and TCID1 and TCID2 are both mapped onto LCIDx.

S1009: The channel management module of the second device stores the mapping relationship among TCID1, LCIDx, and TCID2.

### (3) An SLE Logical Link LCIDy is Successfully Established

S1010: The channel management module of the first device sends an SLE logical link establishment request to an SLE access layer of the first device, where the request carries TCID1 and QoS of a service. The request is used to request the SLE access layer to establish an SLE logical link LCIDy corresponding to TCID1.

S1011: The SLE access layer of the first device and an SLE access layer of the second device perform QoS negotiation, to establish the SLE logical link LCIDy.

S1012: After LCIDy is successfully established, the SLB access layer of the first device sends an LCIDy establishment success notification to the channel management module of the first device. The notification carries a mapping relationship between TCID1 and LCIDy, and is used to notify the channel management module that the SLE logical link LCIDy corresponding to TCID1 is successfully established.

### (4) A Mapping Relationship Between a Service Channel and a Logical Link is Reconfigured

S1013: The channel management module of the first device updates a logical link between TCID1 and TCID2 to LCIDx and LCIDy.

After the channel management module updates the logical link between TCID1 and TCID2 to LCIDx and LCIDy, TCID1 corresponds to TCID2, and TCID1 and TCID2 each are mapped onto LCIDx and LCIDy.

S1014: The channel management module of the first device sends a service channel reconfiguration request to the channel management module of the second device through the SLB control channel/SLE control channel, to request to update the logical link between TCID1 and TCID2 to LCIDx and LCIDy.

S1015: The channel management module of the second device updates the logical link between TCID1 and TCID2 to LCIDx and LCIDy based on the service channel reconfiguration request.

S1016: The channel management module of the second device sends a service channel reconfiguration response message to the channel management module of the first device through the SLB control channel/SLE control channel, to notify the first device that the logical link between TCID1 and TCID2 is updated to LCIDx and LCIDy on a second device side.

Based on steps S1001 to S1016, the first electronic device may establish a one-to-two mapping relationship between TCID1 and both of LCIDx and LCIDy, and simultaneously communicate with the second device at both the SLB access layer and the SLE access layer based on the mapping relationship.

Case 2: An SLB logical link LCIDx is successfully established, and an SLE logical link LCIDy is unsuccessfully established.

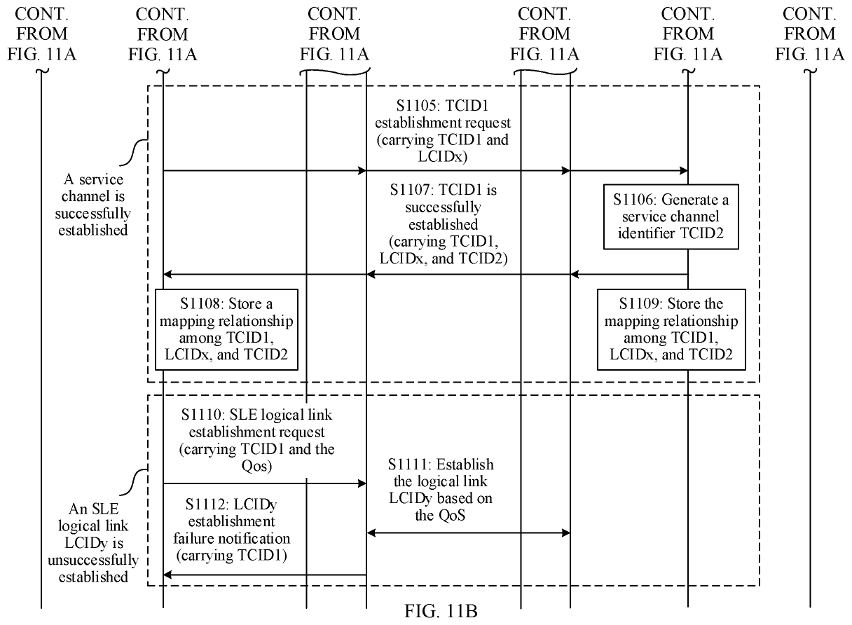

FIG. 11A and FIG. 11B show a procedure of establishing a logical link and a service channel according to another embodiment of this application. Specifically, steps S1101 to S1112 are included, and may be grouped into the following three parts.

### (1) An SLB Logical Link LCIDx is Successfully Established

S1101: A channel management module of a first device generates a service channel identifier TCID1.

S1102: The channel management module of the first device sends an SLB logical link establishment request to an SLB access layer of the first device, where the request carries TCID1 and QoS of a service.

S1103: The SLB access layer of the first device and an SLB access layer of a second device perform QoS negotiation, to establish an SLB logical link LCIDx.

S1104: After LCIDx is successfully established, the SLB access layer of the first device sends an LCIDx establishment success notification to the channel management module of the first device.

### (2) A Service Channel is Successfully Established

S1105: The channel management module of the first device sends a service channel establishment request to a channel management module of the second device through an SLB control channel, where the service channel establishment request carries TCID1 and LCIDx.

S1106: The channel management module of the second device generates a service channel identifier TCID2.

In addition, after generating the service channel identifier TCID2, the second device further needs to establish a mapping relationship between port2 and TCID2, and send the mapping relationship to a basic application layer.

S1107: The channel management module of the second device sends a service channel establishment success notification to the channel management module of the first device through the SLB control channel. The service channel establishment success notification includes a mapping relationship among TCID1, LCIDx, and TCID2, and is used to notify that a service channel between the first device and the second device is successfully established.

After the service channel TCID1 is successfully established, the channel management module further needs to establish a mapping relationship between port1 and TCID1, and send the mapping relationship to the basic application layer.

S1108: The channel management module of the first device stores the mapping relationship among TCID1, LCIDx, and TCID2.

S1109: The channel management module of the second device stores the mapping relationship among TCID1, LCIDx, and TCID2.

### (3) An SLE Logical Link LCIDy is Unsuccessfully Established

S1110: The channel management module of the first device sends an SLE logical link establishment request to an SLE access layer of the first device. The SLE logical link request carries TCID1 and the QoS of the service. The request is used to request the SLE access layer to establish an SLE logical link LCIDy corresponding to TCID1.

S1111: The SLE access layer of the first device and an SLE access layer of the second device perform QoS negotiation, to establish the SLE logical link LCIDy.

S1112: After LCIDy is unsuccessfully established, the SLB access layer of the first device sends an LCIDy establishment failure notification to the channel management module of the first device. The notification carries TCID1, and is used to notify the channel management module that the SLE logical link corresponding to TCID1 is unsuccessfully established.

Based on steps S1101 to S1112, the first device may establish a one-to-one mapping relationship between TCID1 and LCIDx. The first device may communicate with the second device at the SLB access layer based on the mapping relationship.

Case 3: An SLB logical link LCIDx is unsuccessfully established, and an SLE logical link LCIDy is successfully established.

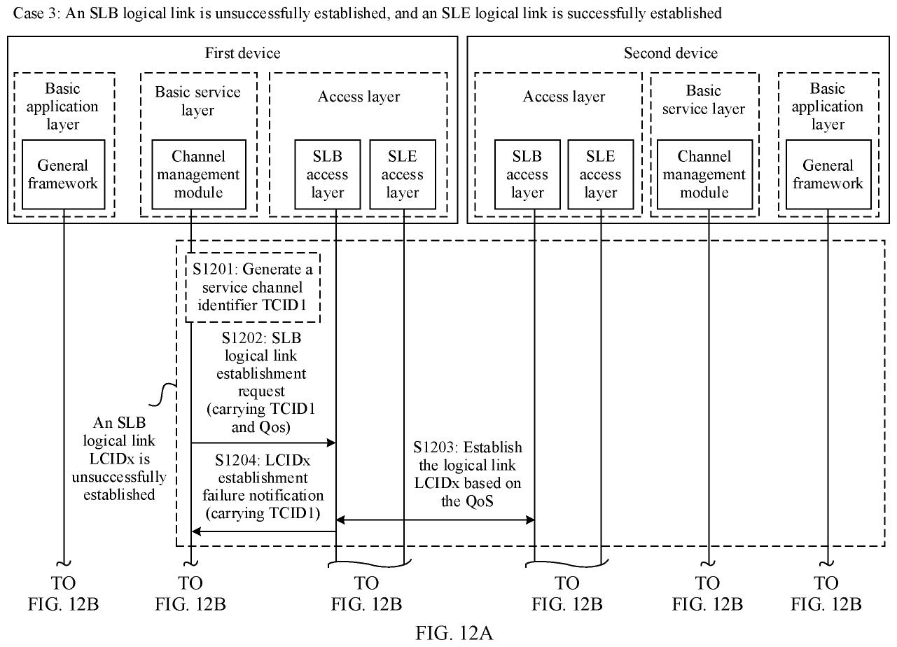

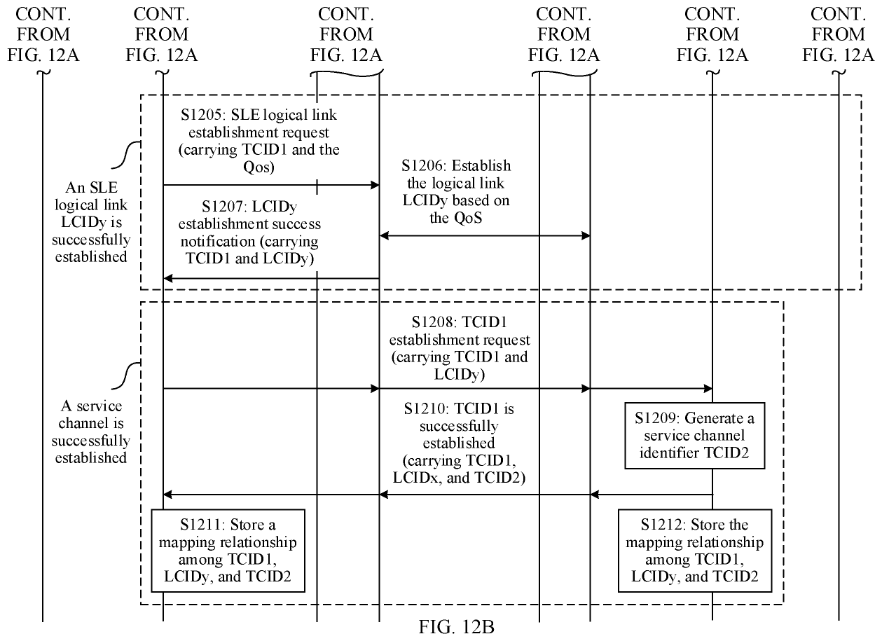

FIG. 12A and FIG. 12B show a procedure of establishing a logical link and a service channel according to still another embodiment of this application. Specifically, steps S1201 to S1212 are included, and may be grouped into the following three parts.

### (1) An SLB Logical Link LCIDx is Unsuccessfully Established

S1201: A channel management module of a first device generates a service channel identifier TCID1.

S1202: The channel management module of the first device sends an SLB logical link establishment request to an SLB access layer of the first device, where the request carries TCID1 and QoS of a service.

S1203: The SLB access layer of the first device and an SLB access layer of a second device establish an SLB logical link LCIDx based on QoS.

S1204: After LCIDx is unsuccessfully established, the SLB access layer of the first device sends an LCIDx establishment failure notification to the channel management module of the first device.

### (2) An SLE Logical Link LCIDy is Successfully Established

S1205: The channel management module of the first device sends an SLE logical link establishment request to an SLE access layer of the first device, where the request carries TCID1 and the QoS of the service. The request is used to request the SLE access layer to establish an SLE logical link LCIDy corresponding to TCID1.

S1206: The SLE access layer of the first device and an SLE access layer of the second device perform QoS negotiation, to successfully establish the SLE logical link LCIDy.

S1207: The SLB access layer of the first device sends an LCIDy establishment success notification to the channel management module of the first device. The notification carries a mapping relationship between TCID1 and LCIDy, and is used to notify the channel management module that the SLE logical link LCIDy corresponding to TCID1 is successfully established.

### (3) A Service Channel is Successfully Established

S1208: The channel management module of the first device sends a service channel establishment request to a channel management module of the second device through an SLE control channel, where the service channel establishment request carries TCID1 and LCIDy.

S1209: The channel management module of the second device generates a service channel identifier TCID2.

In addition, after generating the service channel identifier TCID2, the second device further needs to establish a mapping relationship between port2 and TCID2, and send the mapping relationship to a basic application layer.

S1210: The channel management module of the second device sends a service channel establishment success notification to the channel management module of the first device through the SLE control channel. The service channel establishment success notification includes a mapping relationship among TCID1, LCIDy, and TCID2, and is used to notify that a service channel between the first device and the second device is successfully established.

After the service channel TCID1 is successfully established, the channel management module further needs to establish a mapping relationship between port1 and TCID1, and send the mapping relationship to the basic application layer.

S1211: The channel management module of the first device stores the mapping relationship among TCID1, LCIDy, and TCID2.

S1212: The channel management module of the second device stores the mapping relationship among TCID1, LCIDy, and TCID2.

Based on steps S1201 to S1212, the first device may establish a one-to-one mapping relationship between TCID1 and LCIDy. The first device may communicate with the second device at the SLE access layer based on the mapping relationship.

Case 4: An SLB logical link LCIDx is unsuccessfully established, and an SLE logical link LCIDy is unsuccessfully established.

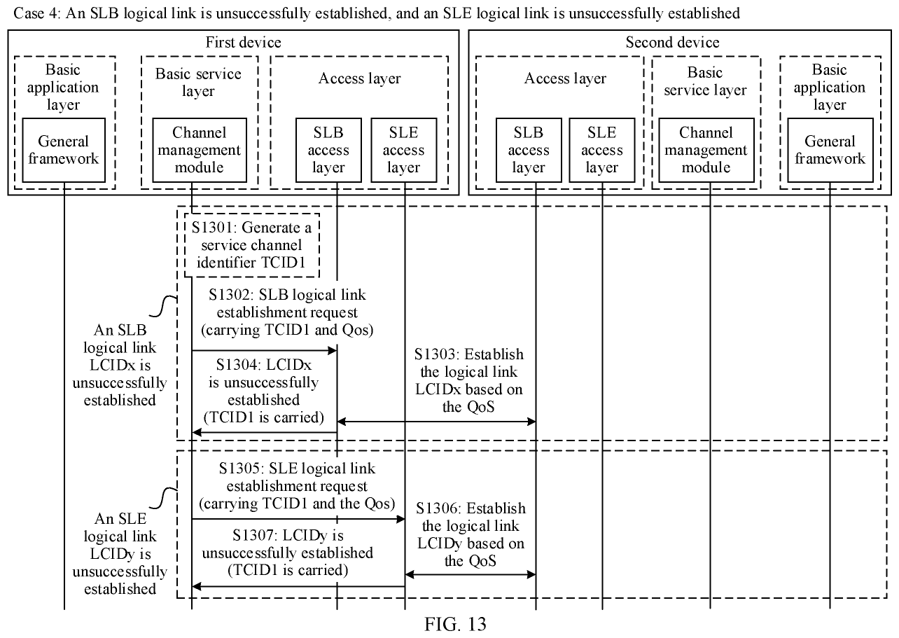

FIG. 13 shows a procedure of establishing a logical link and a service channel according to yet another embodiment of this application. Specifically, steps S1301 to S1307 are included, and may be grouped into the following two parts.

### (1) An SLB Logical Link LCIDx is Unsuccessfully Established

S1301: A channel management module of a first device generates a service channel identifier TCID1.

S1302: The channel management module of the first device sends an SLB logical link establishment request to an SLB access layer of the first device, where the request carries TCID1 and QoS of a service.

S1303: The SLB access layer of the first device and an SLB access layer of a second device establish an SLB logical link LCIDx based on QoS.

S1304: After LCIDx is unsuccessfully established, the SLB access layer of the first device sends an LCIDx establishment failure notification to the channel management module of the first device.

### (2) An SLE Logical Link LCIDy is Unsuccessfully Established

S1305: The channel management module of the first device sends an SLE logical link establishment request to an SLE access layer of the first device. The SLE logical link request carries TCID1 and the QoS of the service. The request is used to request the SLE access layer to establish an SLE logical link LCIDy corresponding to TCID1.

S1306: The SLE access layer of the first device and an SLE access layer of the second device perform QoS negotiation, to establish the SLE logical link LCIDy.

S1307: After LCIDy is unsuccessfully established, the SLB access layer of the first device sends an LCIDy establishment failure notification to the channel management module of the first device. The notification carries TCID1, and is used to notify the channel management module that the SLE logical link corresponding to TCID1 is unsuccessfully established.

It should be understood that when both the SLB logical link LCIDx and the SLE logical link LCIDy between the first device and the second device are unsuccessfully established, the first device cannot establish the service channel.

For a service that supports multilink transmission, if service data of the service is transmitted at only one access layer, an electronic device may switch the service data to another access layer based on a service requirement, including (1) switching the service data from the SLE access layer to the SLB access layer for transmission; and (2) switching the service data from the SLB access layer to the SLE access layer for transmission. The following separately provides descriptions.

(1) Switch Service Data from an SLE Access Layer to an SLB Access Layer for Transmission

It can be learned from the foregoing descriptions that, although a specific service supports multilink transmission, because the SLB access layer is occupied by a high-priority service and remaining resources of the SLB access layer are insufficient to provide a service for the service, the basic service layer currently configures only an SLE logical link for the service. Therefore, service data of the service is currently transmitted to a peer device at an SLE access layer in which the SLE logical link is located. However, when a QoS requirement of the service is improved, a current SLE access layer may be unable to meet a service requirement. Alternatively, after the QoS requirement of the service does not change, but a data transmission capability of an electronic device is improved, transmission quality of the service data cannot be improved if the service data is still transmitted at the SLE access layer. Therefore, in an embodiment of this application, when the SLB access layer recovers to be able to provide a service for the service, the SLB logical link may be reconfigured for the service, and the service data may be switched from the SLE access layer to the SLB access layer for transmission.

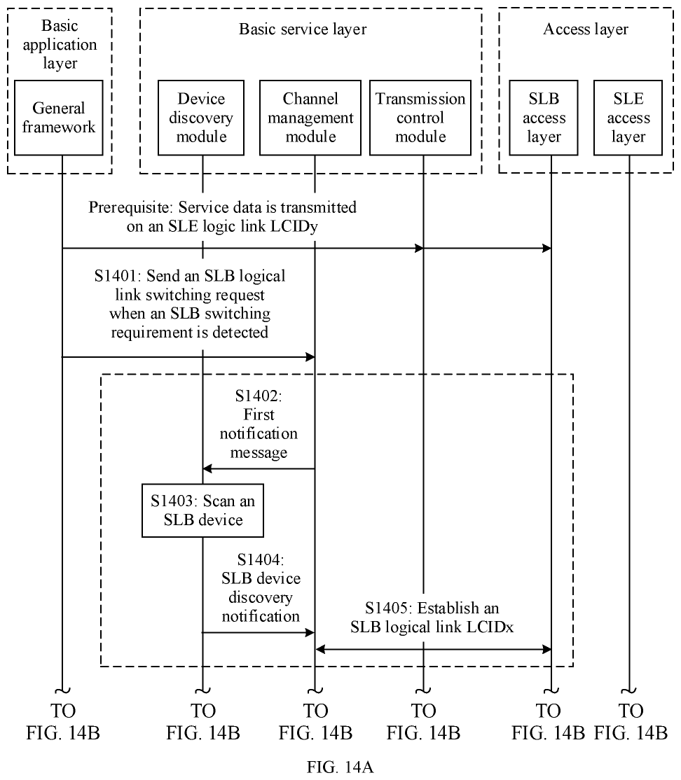

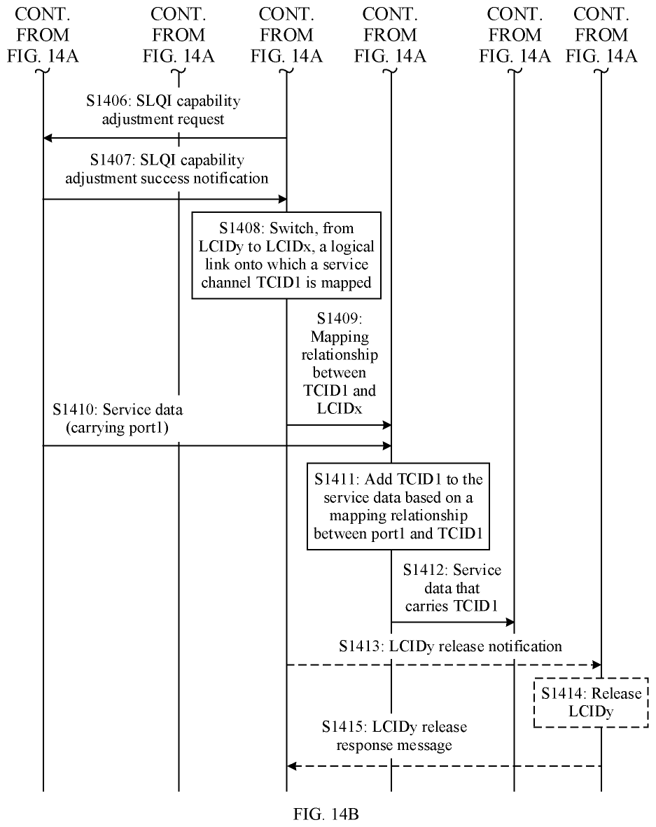

FIG. 14A and FIG. 14B are a flowchart of a data transmission method according to another embodiment of this application, and relates to a process of switching service data from an SLE access layer to an SLB access layer for transmission.

S1401: In a process in which a basic application layer transmits service data through an SLB logical link LCIDy, the basic application layer sends an SLB logical link switching request to a channel management module of a basic service layer after detecting an SLB switching requirement.

In some embodiments, the SLB switching requirement is that a QoS requirement of a current service is improved. For example, in a process in which a mobile phone controls, at the SLE access layer, a wireless headset to play standard-definition audio, if a user switches quality of the audio from standard-definition to high-definition on a mobile phone side, a QoS requirement of an audio playing service is improved, and an application sends a new QoS requirement to the basic application layer. After the basic application layer receives the new QoS requirement, when the new QoS requirement is higher than an original QoS requirement, if the current service can be simultaneously transmitted at the SLB access layer and the SLE access layer, the basic application layer requests the channel management module to switch the service to the SLB access layer for transmission.

In some other embodiments, the SLB switching requirement is to improve an SLQI that can be provided by the basic service layer. For example, when the mobile phone controls a wireless headset to play high-definition audio, a QoS requirement of a high-definition audio playing service is high. However, because an SLB access layer of the basic service layer is occupied by another service, or the like, the basic service layer cannot provide an SLB access layer with a high SLQI (for example, SLQI-A) for the high-definition audio playing service, but provides an SLE access layer with a low SLQI (for example, SLQI-B) for the service. After the application agrees on SLQI-B, the application transmits service data at the SLE access layer.

Because a bandwidth of the SLE access layer is low, congestion may occur in a transmission process of a media stream of the high-definition audio, leading to poor audio playing quality. Therefore, in this embodiment, in a process of executing the high-definition audio playing service, if a service that previously occupies the SLB access layer ends, there is a remaining resource of the SLB access layer, and the channel management module may establish an SLB logical link LCIDx for the service, to switch the service from the SLE access layer to the SLB access layer, transmit service data at a high-bandwidth SLB access layer, improve a data transmission rate, and improve playing quality of the high-definition audio.

In some other embodiments, the SLB switching requirement is that a QoS management module detects that SLE air interface quality is poor, and a bit error rate is high.

In some cases, there is currently an SLB logical link at the basic service layer. After S1401, the basic service layer may directly perform step S1406 based on the SLB logical link. In some other cases, there is currently no SLB logical link at the basic service layer. Therefore, after S1401, the basic service layer needs to first establish the SLB logical link. For a specific establishment process, refer to steps S1402 to S1405.

S1402: The channel management module of the basic service layer sends a first notification message to a device discovery module, where the first notification message indicates the device discovery module to scan an SLB device.

For example, the channel management module may determine, based on a factor such as whether the SLB access layer has a high-priority service or whether a remaining resource of the SLB access layer supports the service, whether the service currently indicates the device discovery module to scan the SLB device.

S1403: The device discovery module scans the SLB device.

S1404: The device discovery module sends an SLB device discovery notification to the channel management module.

In this embodiment, the SLB device discovery notification indicates that the device discovery module finds that a peer device corresponding to the current service supports an SLB communication function.

S1405: The channel management module establishes an SLB logical link LCIDx with a peer device corresponding to the current service.

S1406: The channel management module sends an SLQI capability adjustment request to the basic application layer.

In some embodiments, after the channel management module establishes a new SLB logical link for the service, data transmission quality that can be actually provided by the channel management module for the service also changes. To be specific, data transmission quality SLQI-B provided by the SLE access layer changes to data transmission quality SLQI-A that can be provided by the SLB access layer. Therefore, the channel management module needs to send the SLQI capability adjustment request to the basic application layer, to request to adjust, to SLQI-A, the SLQI provided for the service.

S1407: After the basic application layer agrees to the SLQI capability adjustment request, the basic application layer sends an SLQI capability adjustment success notification to the channel management module. For details, refer to S608. Details are not described herein in this embodiment.

S1408: The channel management module switches, from LCIDy to LCIDx, a logical link onto which a service channel TCID1 is mapped.

A data transmission process is an interaction service between two devices, and the two devices interact with each other through the logical link. Therefore, a first device not only needs to locally switch a logical link of the service from LCIDy to LCIDx, but also needs to notify a second device to switch a service channel from LCIDy to LCIDx.

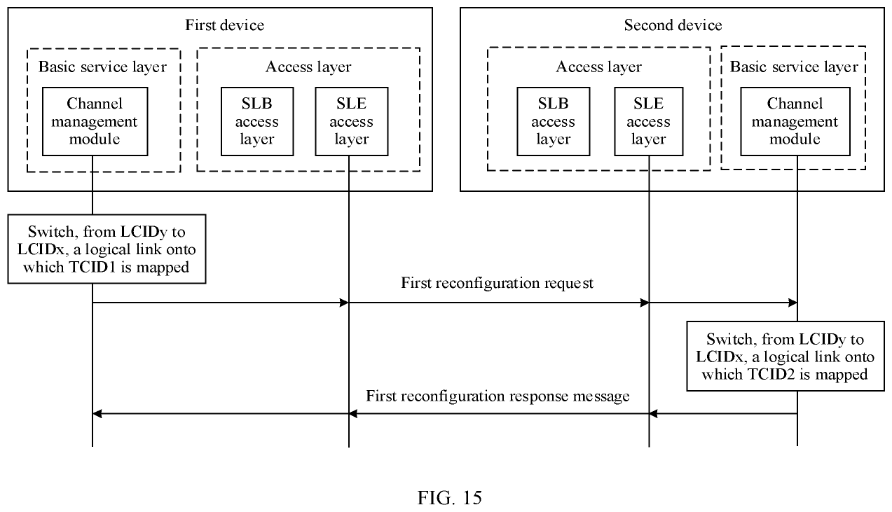

In an example, as shown in FIG. 15, after switching, from LCIDy to LCIDx, a logical link onto which TCID1 is mapped, a channel management module of the first device sends a first reconfiguration request to a channel management module of the second device, to request the second device to switch, from LCIDy to LCIDx, a logical channel onto which a service channel TCID2 that processes the service is mapped. After completing switching, the channel management module of the second device sends a first reconfiguration response message to the channel management module of the first device, to notify that the logical link of TCID2 of the second device is successfully switched.

S1409: The channel management module sends a mapping relationship between TCID1 and LCIDx to a transmission control module.

In some embodiments, after receiving the mapping relationship between TCID1 and LCIDx, the transmission control module deletes a locally and originally stored mapping relationship between TCID1 and LCIDy.

In some other embodiments, after receiving the mapping relationship between TCID1 and LCIDx, the transmission control module may not delete the mapping relationship between TCID1 and LCIDy, so that TCID1 is simultaneously mapped onto LCIDx and LCIDy.

S1410: The basic application layer sends service data to the transmission control module, where the service data carries an identifier of port1.

S1411: The transmission control module adds a TCID1 identifier to the service data based on a mapping relationship between port1 and TCID1.

S1412: The transmission control module sends, to the SLB access layer based on the mapping relationship between TCID1 and LCIDx, service data that carries TCID1. Specifically, after adding the LCIDx identifier to the service data, the SLB access layer sends the service data to the peer device.

S1413: The channel management module sends an LCIDy release notification to the SLE access layer.

S1414: The channel management module releases LCIDy.

S1415: The SLE access layer sends an LCIDy release response message to the channel management module, where the response message is used to notify that LCIDy is successfully released.

It should be noted that S1413 to S1415 are optional steps, and after performing S1412, the electronic device may not perform S1413 to S1415. That is, in a process in which the electronic device transmits the service data through LCIDx, the electronic device may not disconnect LCIDy.

According to the method provided in this embodiment of this application, in a process of performing SLE communication between the electronic device and the peer device corresponding to the current service, the electronic device can switch the service data from the SLE access layer to the SLB access layer for transmission, to improve a data transmission rate between devices. In addition, in a link switching process, a user is imperceptible, to help improve user experience.

(2) Switch Service Data from an SLB Access Layer to an SLE Access Layer for Transmission

It can be learned from the foregoing descriptions that, although a specific service supports multilink transmission, because the SLE access layer is occupied by a high-priority service and remaining resources of the SLE access layer are insufficient to provide a service for the service, the basic service layer currently configures only an SLB logical link for the service. Therefore, the service currently uses the SLB access layer to transmit the service data to the peer device. However, because power consumption of the SLB access layer is large, and a power of a device is lost too fast due to long time use, when an electronic device has a low power consumption requirement, and the SLE access layer is recovered to be able to provide a service for the service, the basic service layer may switch service data of the service from the SLB access layer to the SLE access layer for transmission, to reduce power consumption of the device and improve device use duration.

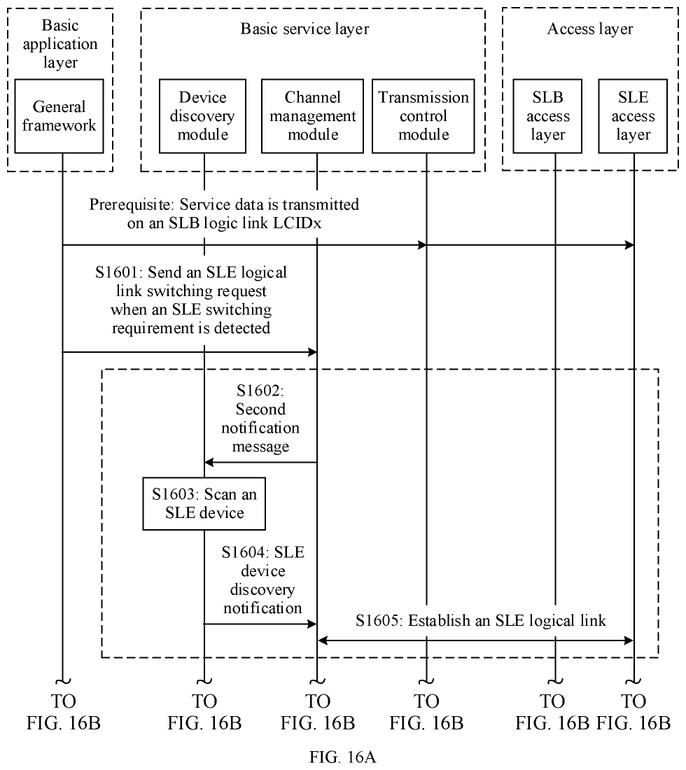

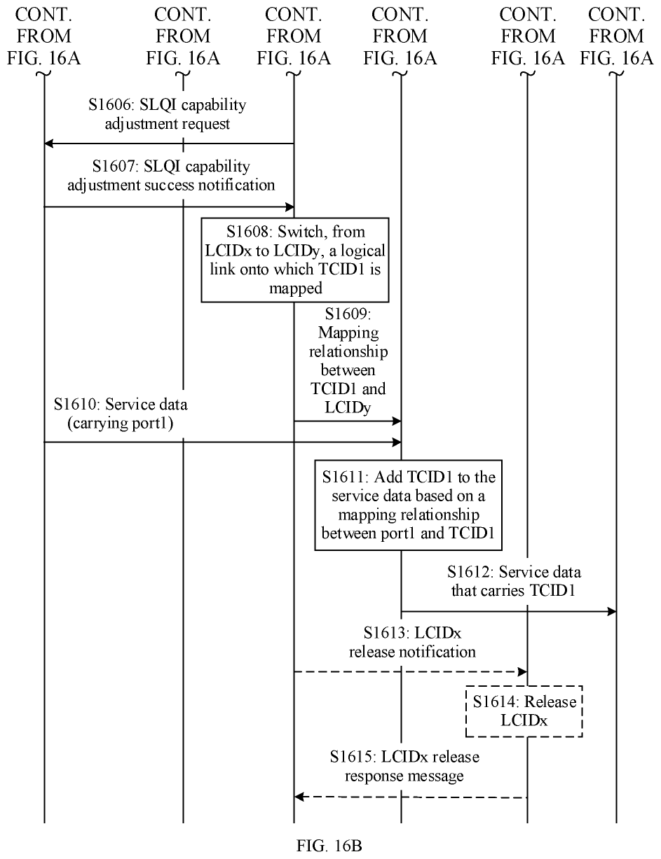

FIG. 16A and FIG. 16B are a flowchart of a data transmission method according to still another embodiment of this application, and relates to a process of switching service data from an SLB access layer to an SLE access layer for transmission.

S1601: In a process in which a basic application layer transmits service data through an SLB logical link LCIDx, the basic application layer sends an SLE logical link switching request to a channel management module of a basic service layer when detecting an SLE switching requirement.

For example, the SLE switching requirement is that a battery power is less than a preset value (for example, 20% of a full charge power), or an electronic device is switched to a power saving mode.

In some cases, the basic service layer currently has an SLE logical link. Based on the SLE logical link, the basic service layer can directly perform step S1606 after S1601, but does not perform S1602 to S1605. In some other cases, there is currently no SLE logical link at the basic service layer. Therefore, after S1601, the basic service layer needs to first establish the SLE logical link. For a specific establishment process, refer to step S1602 to S1605.

S1602: The channel management module of the basic service layer sends a second notification message to a device discovery module, where the second notification message is used to notify the device discovery module to scan an SLE device.

For example, the channel management module may determine, based on a factor such as whether the SLE access layer has a high-priority service or whether a remaining resource of the SLE access layer supports the service, whether to notify the device discovery module to scan the SLE device.

S1603: The device discovery module scans the SLE device.

S1604: The device discovery module sends an SLE device discovery notification to the channel management module.

In this embodiment, the SLE device discovery notification indicates that the device discovery module finds that a peer device corresponding to a current service supports the SLE communication function.

S1605: The channel management module controls the SLE access layer to establish an SLE logical link with the peer device corresponding to the current service.

S1606: The channel management module sends an SLQI capability adjustment request to the basic application layer.

After the channel management module establishes a new SLE logical link for the service, data transmission quality actually provided by a first device for the service also changes. To be specific, data transmission quality SLQI-A that can be provided by the SLB access layer changes to data transmission quality SLQI-B that can be provided by the SLE access layer. Therefore, the channel management module needs to send an SLQI capability adjustment request to the basic application layer, to request to adjust the SLQI provided for the service to SLQI-B.

S1607: After the basic application layer agrees to the SLQI capability adjustment request, the basic application layer sends an SLQI capability adjustment success notification to the channel management module. For details, refer to S608. Details are not described herein in this embodiment.

S1608: The channel management module switches, from LCIDx to LCIDy, a logical link onto which a service channel TCID1 is mapped.

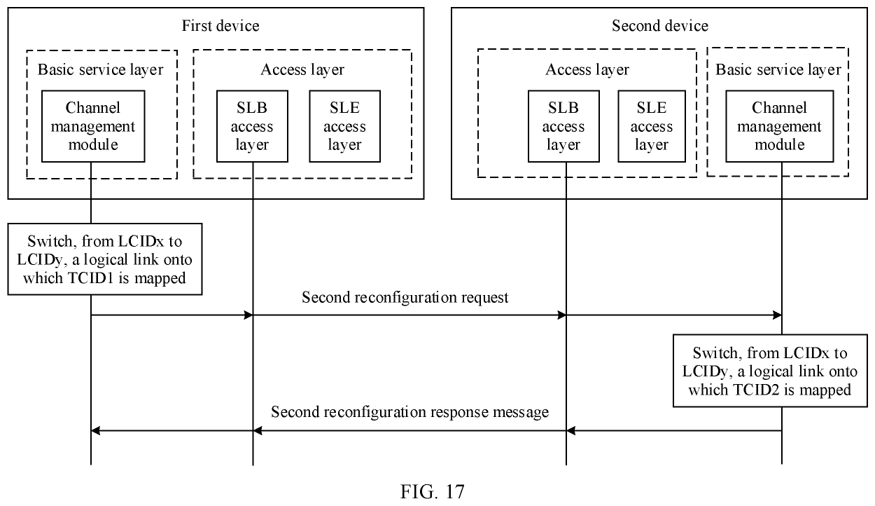

In an example, as shown in FIG. 17, that a local device is the first device and the peer device is a second device is used as an example. After switching, from LCIDx to LCIDy, the logical link onto which the service channel TCID1 is mapped, a channel management module of the first device sends a second reconfiguration request to a channel management module of the second device, to request the second device to switch, from LCIDx to LCIDy, a logical link onto which a service channel TCID2 is mapped. After completing switching, the channel management module of the second device sends a second reconfiguration response message to the channel management module of the first device, to notify that the logical link onto which TCID2 of the second device is mapped is successfully reconfigured.

S1609: The channel management module sends a mapping relationship between TCID1 and LCIDy to a transmission control module.

In some embodiments, after receiving the mapping relationship between TCID1 and LCIDy, the transmission control module may delete a locally and originally stored mapping relationship between TCID1 and LCIDx.

In some other embodiments, after receiving the mapping relationship between TCID1 and LCIDy, the transmission control module may not delete the mapping relationship between TCID1 and LCIDx, so that TCID1 is simultaneously mapped onto LCIDx and LCIDy.

S1610: The basic application layer sends service data to the transmission control module, where the service data carries an identifier of port1.

S1611: The transmission control module adds TCID1 to the service data based on a mapping relationship between port1 and TCID1.

S1612: The transmission control module sends, to the SLE access layer based on the mapping relationship between TCID1 and LCIDy, the service data that carries TCID1. Specifically, after adding LCIDy to the service data, the SLE access layer sends the service data to the peer device.

S1613: The channel management module sends an LCIDx release notification to the SLB access layer.

S1614: The channel management module releases LCIDx.

S1615: The SLE access layer sends an LCIDx release response message to the channel management module, where the response message is used to notify that LCIDx is successfully released.

It should be noted that S1613 and S1614 are optional steps, and after performing S1612, the electronic device may not perform S1613 to S1615. That is, in a process in which the electronic device transmits the service data through LCIDy, the electronic device may not disconnect LCIDx.

According to the method provided in this embodiment of this application, in a process in which the electronic device and the peer device perform communication at the SLB access layer, when the electronic device has a low power consumption requirement, the electronic device can switch the service data from the SLB access layer to the SLE access layer for transmission, to reduce device power consumption and improve device use duration. In addition, in an access layer switching process, both a user and an upper-layer application are imperceptible, to help improve user experience.

It should be understood that sequence numbers of the steps do not mean an execution sequence in embodiments. The execution sequence of the processes needs to be determined based on functions and internal logic of the processes, and should not constitute any limitation on the implementation processes of embodiments of this application.

Based on the data transmission method provided in the foregoing embodiments, embodiments of this application further provide the following technical solutions.

A data transmission apparatus is provided, including a basic application layer, a basic service layer, and an access layer. The access layer includes a first access layer and a second access layer, and the first access layer and the second access layer support different data transmission capabilities.

The basic application layer is configured to request the basic service layer to establish a service channel for a communication service of an application.

The basic service layer is configured to establish, by the basic service layer, a transmission channel group for the communication service if the communication service supports multilink transmission. The transmission channel group includes a first service channel and/or a second service channel, the first service channel corresponds to the first access layer, and the second service channel corresponds to the second access layer.

The access layer is configured to transmit service data based on the transmission channel group.

Optionally, the first access layer is a SparkLink basic SLB access layer, the first service channel is an SLB service channel, and the SLB access layer supports a high-bandwidth data transmission capability; and the second access layer is a SparkLink low energy SLE access layer, the second service channel is an SLE service channel, and the SLE access layer supports a low-power data transmission capability. According to the method provided in this embodiment of this application, the electronic device can provide a high-bandwidth and/or low-power data transmission capability for the communication service.

Optionally, the basic service layer is further configured to: if the communication service supports multilink transmission, allocate, by the basic service layer, the first service channel to the transmission channel group of the communication service when a resource of the first access layer supports to serve the communication service, and is not occupied by another service whose priority is higher than that of the communication service; and/or if the communication service supports multilink transmission, allocate, by the basic service layer, the second service channel to the transmission channel group of the communication service when a resource of the second access layer supports to serve the communication service, and is not occupied by another service whose priority is higher than that of the communication service.

Optionally, the basic service layer is further configured to: transmit the service data through the first service channel and the second service channel; or individually transmit, by the electronic device, the service data through the first service channel; or individually transmit, by the electronic device, the service data through the second service channel.

Optionally, the basic service layer is further configured to: obtain target service data from the basic application layer, where the target service data is service data that carries a port number (port), and the port is mapped onto all service channels in the transmission channel group; process the target service data, to obtain target service data that carries a first TCID and target service data that carries a second TCID, where the first TCID is an identifier of the first service channel, and the second TCID is an identifier of the second service channel; and send, to the first access layer, the target service data that carries the first TCID, and send, to the second access layer, the target service data that carries the second TCID.

The access layer is further configured to: transmit, at the first access layer, the target service data that carries the first TCID, and transmit, at the second access layer, the target service data that carries the second TCID.

Optionally, the basic service layer is further configured to: obtain target service data from the basic application layer, where the target service data is service data that carries a port number (port); process the target service data that carries the port, to obtain target service data that carries a first TCID; and send, to the first access layer, target service data that carries the first TCID.

The first access layer is further configured to send, to a peer device, the target service data that carries the first TCID.

Optionally, the basic application layer is further configured to: receive the service data sent by the application; and add the port to the service data, to obtain the target service data.

Optionally, the basic application layer is further configured to: if the transmission channel group includes an original service channel, the original service channel is either of the first service channel and the second service channel, the basic service layer determines to switch to a target service channel to process the communication service, and an access layer corresponding to the target service channel can provide a service for the communication service, update, by the basic service layer, the transmission channel group, where the updated transmission channel group further includes the target service channel; and switch the service data to the target service channel for transmission. The target service channel is the second service channel when the transmission channel group before updating includes the first service channel; and the target service channel is the first service channel when the transmission channel group before updating includes the second service channel.

Optionally, the basic service layer is further configured to: disconnect the original service channel in the transmission channel group, and switch the service data to the target service channel.

Optionally, determining to switch to the target service channel to process the communication service includes: the electronic device enters a low power mode, or power of the electronic device is less than a preset value, and correspondingly, the target service channel is the second service channel, and the second service channel supports a low-power data transmission capability.

Optionally, determining to switch to the target service channel to process the communication service includes: a quality of service requirement of the communication service is improved, or a service capability of an access layer corresponding to the target service channel is improved, and correspondingly, the target service channel is the first service channel, and the first service channel supports a high-bandwidth data transmission capability.

A data transmission apparatus is provided, and includes a basic application layer, a basic service layer, and an access layer, the access layer includes a first access layer and a second access layer, and the first access layer and the second access layer support different data transmission capabilities.

The basic application layer is configured to request the basic service layer to establish a service channel for a communication service of an application.

The basic service layer is configured to establish the service channel for the communication service if the communication service supports multilink transmission. The service channel can be mapped onto a first logical link and a second logical link, the first logical link is a link of the first access layer, and the second logical link is a link of the second access layer.

The access layer is configured to: establish a logical link, and transmit service data of the communication service to a peer device through the first logical link and/or the second logical link.

Optionally, that the service channel can be mapped onto the first logical link and the second logical link includes: The service channel is simultaneously mapped onto the first logical link and the second logical link; or the service channel is separately map onto the first logical link and the second logical link at different stages of service data transmission.

Optionally, the first access layer is a SparkLink basic SLB access layer, the first logical link is an SLB service channel, and the SLB access layer supports a high-bandwidth data transmission capability; and the second access layer is a SparkLink low energy SLE access layer, the second logical link is an SLE logical link, and the SLE access layer supports a low-power data transmission capability.

Optionally, if the service channel is simultaneously mapped onto the first logical link and the second logical link, the access layer is further configured to: simultaneously transmit the service data at the first access layer and the second access layer; or transmit the service data at only the first access layer; or transmit the service data at only the second access layer.

Optionally, the basic service layer is further configured to: obtain target service data from the basic application layer, where the target service data is service data that carries a port number (port); and add a service channel identifier TCID to the target service data; send, to the first access layer, first service data in the target service data that carries the TCID; and send, to the second access layer, second service data in the target service data that carries the TCID.

The first access layer is further configured to: add a first logical link identifier LCID to the first service data, and send, to the peer device, the first service data that carries the first LCID.

The second access layer is further configured to: add a second LCID to the second service data, and send, to the peer device, the second service data that carries the second LCID.

Optionally, the basic service layer is further configured to obtain target service data from the basic application layer, where the target service data is service data that carries a port number (port). The basic service layer adds a TCID to the target service data, and sends, to the first access layer, the target service data that carries the TCID.

The first access layer is further configured to: add a first LCID to the target service data that carries the TCID, and send, to the peer device, the target service data that carries the first LCID.

Optionally, the basic application layer is further configured to: receive the service data sent by the application; and add a port to the service data.

Optionally, the basic service layer is further configured to: establish, by the basic service layer, a mapping relationship between the service channel and the target logical link if the service channel is mapped onto an original logical link, and the basic service layer determines to switch to the target logical link to process the communication service; and switch the service data to the target logical link for transmission. The target logical link is the second logical link when the original logical link is the first logical link; or the target logical link is the first logical link when the original logical link is the second logical link.

Optionally, the basic service layer is further configured to: release the original logical link, and switch the service data to the target logical link for transmission.

Optionally, determining to switch to the target logical link to process the communication service includes: the electronic device enters a low power mode, or a power of the electronic device is less than a preset value, and correspondingly, the target logical link is the second logical link, and the second logical link supports a low-power data transmission capability.

Optionally, determining to switch to the target logical link to process the communication service includes: a quality of service requirement of the communication service is improved, or a service capability of the target logical link is improved, and correspondingly, the target service channel is the first logical link, and the first logical link supports a high-bandwidth data transmission capability.

An embodiment of this application further provides another data transmission apparatus. The apparatus includes a processor and a memory, the memory stores a computer program, and when the computer program is executed by a processor, the data transmission method in the foregoing embodiments is implemented.

An embodiment of this application further provides an electronic device. The electronic device includes a wireless short-range communication protocol architecture provided in the foregoing embodiments, and is configured to perform the data transmission method shown in the foregoing embodiments.

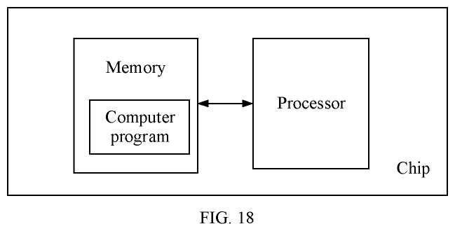

An embodiment of this application further provides a chip. As shown in FIG. 18, the chip includes a processor and a memory, the memory stores a computer program, and when the computer program is executed by a processor, the data transmission method in the foregoing embodiments is implemented.

An embodiment of this application further provides a computer-readable storage medium. The computer-readable storage medium stores a computer program. When the computer program is executed by a processor, the data transmission method in the foregoing embodiments is implemented.

An embodiment of this application further provides a computer program product. The program product includes a computer program. When the computer program is run by an electronic device, the electronic device is enabled to implement the data transmission method provided in the foregoing embodiments.

It should be understood that, the processor in embodiments of this application may be a central processing unit (central processing unit, CPU), another general-purpose processor, a digital signal processor (digital signal processor, DSP), an application-specific integrated circuit (application-specific integrated circuit, ASIC), a field programmable gate array (field programmable gate array, FPGA) or another programmable logic device, a discrete gate or transistor logic device, a discrete hardware component, or the like. The general-purpose processor may be a microprocessor, or the processor may be any conventional processor, or the like.

It may be further understood that the memory mentioned in embodiments of this application may be a volatile memory or a nonvolatile memory, or may include a volatile memory and a nonvolatile memory. The nonvolatile memory may be a read-only memory (read-only memory, ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (random access memory, RAM), and is used as an external cache. Through examples but not limitative descriptions, many forms of RAMs may be used, for example, a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchronous link dynamic random access memory (synchlink DRAM, SLDRAM), and a direct rambus random access memory (direct rambus RAM, DR RAM).

In embodiments provided in this application, division into frameworks or modules is merely logical functional division and can be other division in an actual implementation. For example, a plurality of frameworks or modules may be combined or integrated into another system, or some features can be ignored or not performed.

In addition, functional modules in embodiments of this application may be integrated into one processing module, or each module may exist alone physically, or two or more modules may be integrated into one module. The integrated module may be implemented in a form of hardware, or may be implemented in a form of a software functional module.

A person skilled in the art may clearly understand that, for the purpose of convenient and brief description, for a detailed working process of the system, apparatus, and unit, refer to a corresponding process in the method embodiments. Details are not described herein again.

Reference to “an embodiment”, “some embodiments”, or the like described in this specification of this application indicates that one or more embodiments of this application include a specific feature, structure, or characteristic described with reference to embodiments. Therefore, statements such as “in an embodiment”, “in some embodiments”, “in some other embodiments”, and “in other embodiments” that appear at different places in this specification do not necessarily mean reference to a same embodiment, instead, they mean “one or more but not all of embodiments”, unless otherwise specifically emphasized. The terms “include”, “comprise”, “have”, and their variants all mean “including but not limited to”, unless otherwise specifically emphasized.

The foregoing embodiments are only used to explain the technical solutions of this application, and are not intended to limit this application. Although this application is described in detail with reference to the foregoing embodiments, a person of ordinary skill in the art should understand that they can still modify the technical solutions described in the foregoing embodiments, or make equivalent substitutions on some technical features therein. These modifications or substitutions do not make the essence of the corresponding technical solutions deviate from the spirit and scope of the technical solutions of embodiments of this application, and shall fall within the protection scope of this application.

1. A data transmission method comprising:
requesting, using a basic application layer of an electronic device, a basic service layer of the electronic device to establish a service channel for a communication service of an application, wherein the service channel is mapped to a first logical link of a first access layer of the electronic device and to a second logical link of a second access layer of the electronic device, and wherein the first access layer and the second access layer support different data transmission capabilities;
establishing, using the basic service layer, the service channel when the communication service supports multilink transmission and
transmitting, at one or more of the first access layer or the second access layer and to a peer device, first service data of the communication service.

2. The data transmission method of claim 1, wherein the service channel is mapped to the first logical link and to the second logical link in a simultaneous manner or a separate manner at different stages of data service transmission.

3. The data transmission method of claim 1, wherein the first access layer is a first SparkLink basic (SLB) access layer that supports a high-bandwidth data transmission capability, wherein the first logical link is a first SLB logical link, wherein the second access layer is a second SparkLink low energy (SLE) access layer that supports a low-power data transmission capability, and wherein the second logical link is a second SLE logical link.

4. The data transmission method of claim 2, wherein when mapping the service channel in the simultaneous manner, the data transmission method further comprises:
separately sending, to the first logical link and to the second logical link, the first service data in the service channel to instruct at one or more of the first access layer and the second access layer to simultaneously transmit second service data at the first access layer and third service data at the second access layer;
sending, to the first logical link, the first service data in the service channel to transmit the second service data at the first access layer; or
sending, to the second logical link, the first service data in the service channel to transmit the third service data at the second access layer.

5. The data transmission method of claim 4, wherein separately sending the first service data in the service channel comprises:
obtaining, from the basic application layer using the basic service layer, target service data carrying a port number;
adding, using the basic service layer, a service channel identifier (TCID) to the target service data;
sending, to the first access layer, the second service data in the target service data that carries the TCID;
sending, to the second access layer, the third service data in the target service data that carries the TCID;
adding, using the first access layer, a first logical link identifier (LCID) to the second service data;
sending, to the peer device, the second service data that carries the first LCID;
adding, using the second access layer, a second LCID to the third service data; and
sending, to the peer device, the third service data that carries the second LCID.

6. The data transmission method of claim 4, wherein sending the first service data in the service channel comprises:
obtaining, from the basic application layer using the basic service layer, target service data carrying a port number;
adding, using the basic service layer, a service channel identifier (TCID) to the target service data;
sending, to the first access layer, the target service data that carries the TCID;
adding, using the first access layer, a logical link identifier (LCID) to the target service data that carries the TCID; and
sending, to the peer device, the target service data that carries the LCID.

7. The data transmission method of claim 5, wherein before obtaining the target service data, the data transmission method further comprises:
receiving, from the application using the basic application layer, the first service data; and
adding, using the basic application layer, a port to the first service data to obtain the target service data.

8. The data transmission method of claim 1, wherein is separately mapping the service channel to the first logical link and to the second logical link comprises:
establishing, using the basic service layer, a mapping relationship between the service channel and a target logical link when the service channel is mapped onto an original logical link and the basic service layer determines to switch to the target logical link to process the communication service, wherein the target logical link is the second logical link when the original logical link is the first logical link, or the target logical link is the first logical link when the original logical link is the second logical link; and
switching the first service data to the target logical link for transmission.

9. The data transmission method of claim 8, wherein switching the first service data to the target logical link comprises:
releasing the original logical link; and
switching, in response to releasing the original logical link, the first service data to the target logical link for the transmission.

10. The data transmission method of claim 8, wherein determining to switch to the target logical link comprises entering the electronic device into a low power mode or identifying that a power of the electronic device is less than a preset value, wherein the target logical link is the second logical link, and wherein the second logical link supports a low-power data transmission capability.

11. The data transmission method of claim 8, wherein determining to switch to the target logical link comprises identifying that a quality of service requirement of the communication service is improved or a service capability of the target logical link is improved, wherein the target service channel is the first logical link, and wherein the first logical link supports a high-bandwidth data transmission capability.

12. A chip comprising:
a memory configured to store instructions; and
a processor coupled to the memory and configured to execute the instructions to cause the chip to:
request a basic service layer to establish a service channel for a communication service of an application, wherein the service channel is mapped onto a first logical link of a first access layer and a second logical link of a second access layer;
establish the service channel when the communication service supports multilink transmission; and
transmit, at one or more of the first access layer or the second access layer and to a peer device, first service data of the communication service.

13. The chip of claim 12, wherein the processor is further configured to execute the instructions to cause the chip to map the service channel onto the first logical link and the second logical link in a simultaneous manner in a separate manner at different stages of service data transmission.

14. The chip of claim 12, wherein the first access layer is a SparkLink basic (SLB) access layer that supports a high-bandwidth data transmission capability, wherein the first logical link is an SLB logical link, the second access layer is a SparkLink low energy (SLE) access layer that supports a low-power data transmission capability, and wherein the second logical link is an SLE logical link.

15. The chip of claim 13, wherein when mapping the service channel in the simultaneous manner, the processor is further configured to execute the instructions to cause the chip to:
separately send the first service data in the service channel to the first logical link and the second logical link, to instruct at one or more of the first access layer and the second access layer to simultaneously transmit second service data at the first access layer and third service data at the second access layer;
send the first service data in the service channel to the first logical link to transmit the second service data at the first access layer; or
send the first service data in the service channel to the second logical link to transmit the third service data at the second access layer.

16. The chip of claim 12, wherein the service channel is separately mapped, at different stages of service data transmission, to the first logical link and to the second logical link and wherein the processor is further configured to execute the instructions to cause the chip to:
establish a mapping relationship between the service channel and a target logical link when the service channel is mapped onto an original logical link and the basic service layer determines to switch to the target logical link to process the communication service wherein the target logical link is the second logical link when the original logical link is the first logical link, or wherein the target logical link is the first logical link when the original logical link is the second logical link; and
switch the first service data to the target logical link for transmission.

17. A computer program product comprising computer-executable instructions that are stored on a non-transitory computer-readable storage medium and that, executed by a processor, cause an electronic device to:
request a basic service layer of the electronic device to establish a service channel for a communication service of an application, wherein the service channel is mapped onto a first logical link of a first access layer of the electronic device and a second logical link of a second access layer of the electronic device;
establish the service channel when the communication service supports multilink transmission; and
transmit, at one or more of the first access layer or the second access layer and to a peer device, service data of the communication service.

18. The computer program product of claim 17, wherein the computer-executable instructions, when executed by the processor, further cause the electronic device to map the service channel onto the first logical link and the second logical link in a simultaneous manner or in a separate manner at different stages of service data transmission.

19. The computer program product of claim 17, wherein the first access layer is a SparkLink basic (SLB) access layer that supports a high-bandwidth data transmission capability, wherein the first logical link is an SLB logical link, wherein the second access layer is a SparkLink low energy (SLE) access layer that supports a low-power data transmission capability, and wherein the second logical link is an SLE logical link.

20. The computer program product of claim 17, wherein the service channel is separately mapped, at different stages of service data transmission, to the first logical link and to the second logical link at different stages of service data transmission, and wherein the computer-executable instructions, when executed by the processor, further cause the electronic device to:
establish a mapping relationship between the service channel and a target logical link when the service channel is mapped onto an original logical link and the basic service layer determines to switch to the target logical link to process the communication service, wherein the target logical link is the second logical link when the original logical link is the first logical link, or wherein the target logical link is the first logical link when the original logical link is the second logical link; and
switch the service data to the target logical link for transmission.
